(19) United States
(12) Patent Application Publication
(10) Pub. No.: US 2022/0149428 A1
(43) Pub. Date: May 12, 2022

(54) PRECURSOR SOLUTION OF SOLID ELECTROLYTE

(71) Applicant: Seiko Epson Corporation, Tokyo (JP)

(72) Inventors: Hitoshi YAMAMOTO, Chino (JP); Tomofumi YOKOYAMA, Matsumoto (JP); Tsutomu TERAOKA, Matsumoto (JP)

(21) Appl. No.: 17/438,507

(22) PCT Filed: Nov. 21, 2019
(86) PCT No.: PCT/JP2019/045707

§ 371 Date: Sep. 13, 2021

(30) Foreign Application Priority Data
Mar. 14, 2019 (JP) 2019-046839

(51) Int. Cl. H01M 10/0562; H01M 10/0525; C01G 33/00; C01G 25/00

(52) U.S. Cl. CPC H01M 10/0562; H01M 10/0525; C01G 33/006; C01P 2002/52; H01M 2300/0071; C01P 2006/40; C01G 25/006

(57) ABSTRACT

A precursor solution of a garnet-type solid electrolyte is provided represented by the compositional formula: Li₇₋ₓLa₃(Zr₂₋ₓMₓ)O₁₂, wherein in the compositional formula, the element M is two or more types of elements selected from Nb, Ta, and Sb, and x satisfies 0.0<x<2.0, the precursor solution contains one type of solvent, and a lithium compound, a lanthanum compound, a zirconium compound, and a compound containing the element M, each of which has solubility in the solvent, and with respect to the stoichiometric composition of the compositional formula, the amount of the lithium compound is 1.05 times or more and 1.20 times or less, the amount of the lanthanum compound is equal, the amount of the zirconium compound is equal, and the amount of the compound containing the element M is equal.

### CROSS REFERENCE TO RELATED APPLICATIONS

The present application is based on International Application No. PCT/JP2019/045707, filed on Nov. 21, 2019, and claims priority from JP Application Serial Number 2019-046839, filed on Mar. 14, 2019, the disclosure of which is hereby incorporated by reference herein in its entirety.

### BACKGROUND

### Technical Field

The present invention relates to a precursor solution of a solid electrolyte to be used in a secondary battery.

### Related Art

Recently, a lithium secondary battery has been adopted as a power supply for various electronic apparatuses and moving objects such as automobiles because a high electromotive force can be obtained. For example, JP-A-2016-72210 discloses a lithium secondary battery including a solid electrolyte layer and a lithium reduction resistant layer disposed in contact with the solid electrolyte layer, wherein the lithium reduction resistant layer contains a compound represented by the following compositional formula (1), and an interface between the lithium reduction resistant layer and the solid electrolyte layer is a continuous layer between the lithium reduction resistant layer and the solid electrolyte layer.

Li₇₋ₓLa₃(Zr₂₋ₓMₓ)O₁₂ (1)

A metal M in the formula represents at least one type selected from Nb, Sc, Ti, V, Y, Hf, Ta, Al, Si, Ga, Ge, Sn, and Sb, and X represents 0 to 2.

Further, the above-mentioned JP-A-2016-72210 discloses a method for forming a lithium reduction resistant layer including a first step of forming a liquid coating film using a composition for forming a lithium reduction resistant layer containing a solvent, and a lithium compound, a lanthanum compound, a zirconium compound, and a compound containing a metal M, each of which has solubility in the solvent, based on the stoichiometric composition of the above compositional formula (1), and a second step of heating the liquid coating film. The composition represented by the above compositional formula (1) is a garnet-type solid electrolyte.

It is said that as the solvent of the composition for forming a lithium reduction resistant layer of the above-mentioned JP-A-2016-72210, any of water, a single organic solvent, a mixed solvent containing water and at least one type of organic solvent, and a mixed solvent containing at least two or more types of organic solvents can be applied.

However, when a mixed solvent is used, the boiling points of the multiple types of solvents contained in the mixed solvent are not always the same, and the solubility of each of the lithium compound, the lanthanum compound, the zirconium compound, and the compound containing the metal M in the multiple types of solvents is not the same, and therefore, a byproduct is likely to be generated in firing in a process for forming a solid electrolyte. When a byproduct is generated, a solid electrolyte having a target composition cannot be obtained, and therefore, it had a problem that a solid electrolyte having a desired ion conductivity cannot be achieved.

### SUMMARY

A precursor solution of a solid electrolyte of this application is a precursor solution of a garnet-type solid electrolyte represented by the compositional formula: Li₇₋ₓLa₃(Zr₂₋ₓMₓ)O₁₂, and is characterized in that in the compositional formula, the element M is two or more types of elements selected from Nb, Ta, and Sb, and x satisfies 0.0<x<2.0, the precursor solution contains one type of organic solvent, and a lithium compound, a lanthanum compound, a zirconium compound, and a compound containing the element M, each of which has solubility in the organic solvent, and with respect to the stoichiometric composition of the above compositional formula, the amount of the lithium compound is 1.05 times or more and 1.20 times or less, the amount of the lanthanum compound is equal, the amount of the zirconium compound is equal, and the amount of the compound containing the element M is equal.

Note that the garnet-type solid electrolyte represented by the above compositional formula refers to a solid electrolyte having a garnet-type crystal structure or a garnet-like crystal structure.

In the precursor solution of a solid electrolyte described above, it is preferred that the lithium compound is a lithium metal salt compound, the lanthanum compound is a lanthanum metal salt compound, the zirconium compound is a zirconium alkoxide, and the compound containing the element M is an alkoxide of the element M.

In the precursor solution of a solid electrolyte described above, it is preferred that the lithium metal salt compound and the lanthanum metal salt compound are nitrates.

It is preferred that the amount of moisture contained in the precursor solution of a solid electrolyte described above is 10 ppm or less.

In the precursor solution of a solid electrolyte described above, it is preferred that the zirconium alkoxide and the alkoxide of the element M have 4 or more and 8 or less carbon atoms or have a boiling point of 300° C. or higher.

In the precursor solution of a solid electrolyte described above, it is preferred that the organic solvent is nonaqueous and is selected from n-butyl alcohol, ethylene glycol monobutyl ether, butylene glycol, hexylene glycol, pentanediol, hexanediol, heptanediol, toluene, o-xylene, p-xylene, hexane, heptane, and octane.

### BRIEF DESCRIPTION OF THE DRAWINGS

FIG. 1 is a schematic perspective view showing a configuration of a lithium-ion battery as a secondary battery of the present embodiment.

FIG. 2 is a schematic cross-sectional view showing a structure of the lithium-ion battery as the secondary battery of the present embodiment.

FIG. 3 is a flowchart showing a method for producing a precursor solution of a garnet-type solid electrolyte of the present embodiment.

FIG. 4 is a flowchart showing a method for producing a lithium-ion battery of the present embodiment.

FIG. 5 is a schematic view showing a step in the method for producing a lithium-ion battery of the present embodiment.

FIG. 6 is a schematic view showing a step in the method for producing a lithium-ion battery of the present embodiment.

FIG. 7 is a schematic view showing another method for forming a positive electrode composite.

### DETAILED DESCRIPTION

Hereinafter, embodiments of the invention will be described with reference to the drawings. Note that in the respective drawings below, portions to be described are shown by being appropriately enlarged or reduced in size so as to have a recognizable size.

### 1. Embodiments

### 1-1. Secondary Battery

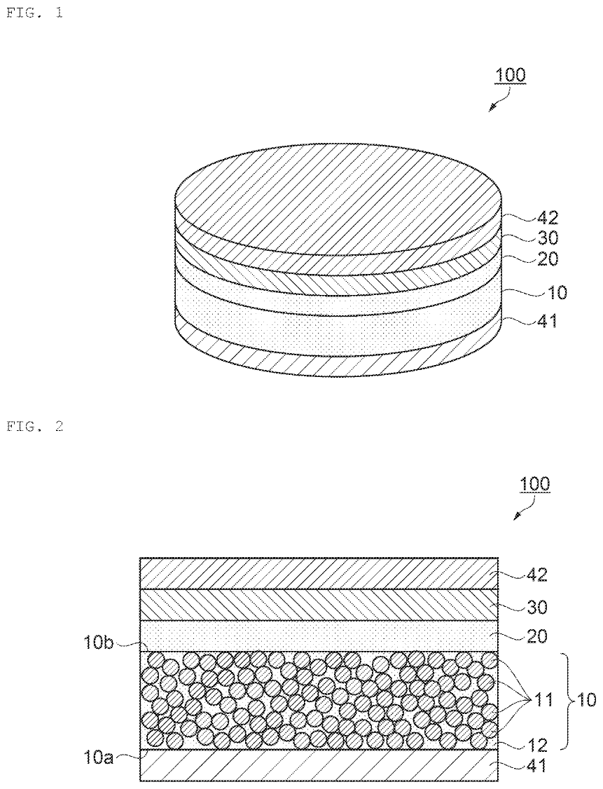

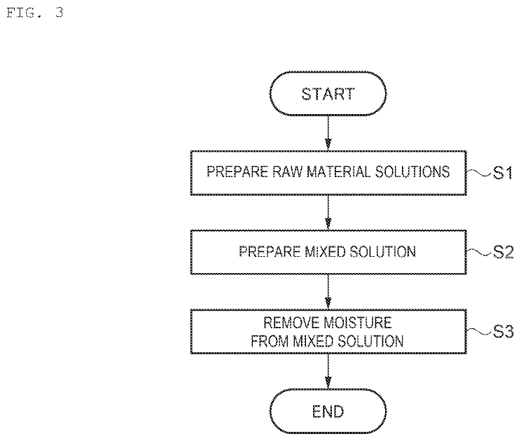

First, a secondary battery including a solid electrolyte formed using a precursor solution of a garnet-type solid electrolyte of this embodiment will be described by showing a lithium-ion battery as an example with reference to FIGS. 1 and 2. FIG. 1 is a schematic perspective view showing a configuration of a lithium-ion battery as the secondary battery of this embodiment, and FIG. 2 is a schematic cross-sectional view showing a structure of the lithium-ion battery as the secondary battery of this embodiment.

As shown in FIG. 1, a lithium-ion battery 100 as the secondary battery of this embodiment includes a positive electrode composite 10 that functions as a positive electrode, and an electrolyte layer 20 and a negative electrode 30, which are sequentially stacked for the positive electrode composite 10. Further, the lithium-ion battery includes a current collector 41 in contact with the positive electrode composite 10 and a current collector 42 in contact with the negative electrode 30. The positive electrode composite 10, the electrolyte layer 20, and the negative electrode 30 are all constituted by a solid phase, and therefore, the lithium-ion battery 100 of this embodiment is an all solid-state secondary battery that can be charged and discharged.

The lithium-ion battery 100 of this embodiment has, for example, a circular disk shape, and the contour size thereof is such that the diameter ϕ is, for example, from 10 to 20 mm and the thickness is, for example, about 0.3 mm. In addition to being small and thin, the lithium-ion battery can be charged and discharged and is in an all solid state, and therefore can be favorably used as a power supply for a portable information terminal such as a wearable apparatus. The size and the thickness of the lithium-ion battery 100 are not limited to the above values as long as it can be molded. In a case where the contour size thereof is from 10 to 20 mm ϕ as in this embodiment, the thickness from the positive electrode composite 10 to the negative electrode 30 is about 0.1 mm from the viewpoint of moldability when it is thin, and is up to about 1 mm estimated from the viewpoint of lithium ion conduction property when it is thick, and if it is too thick, the utilization efficiency of the active material is deteriorated. Note that the shape of the lithium-ion battery 100 is not limited to a circular disk shape, and may be a polygonal disk shape. Hereinafter, the respective configurations will be described in detail.

### 1-1-1. Positive Electrode Composite

As shown in FIG. 2, the positive electrode composite 10 is configured to include a positive electrode active material 11 in a particulate shape and a solid electrolyte 12. The positive electrode composite 10 is in a state where the solid electrolyte 12 fills up a void generated by mutual contact of the positive electrode active materials 11 in a particulate shape. The solid electrolyte 12 is one formed using the precursor solution of a solid electrolyte of this embodiment.

As the positive electrode active material 11 of this embodiment, any material may be used as long as it can repeat electrochemical occlusion and release of lithium ions. Specifically, it is preferred to use a lithium composite metal oxide containing at least lithium (Li) and also containing at least one type of transition metal selected from vanadium (V), chromium (Cr), manganese (Mn), iron (Fe), cobalt (Co), nickel (Ni), and copper (Cu) as a constituent element because it is chemically stable. Examples of such a lithium composite metal oxide include LiCoO₂, LiNiO₂, LiMn₂O₄, Li₂Mn₂O₃, NMC (Li(NiₓMn_{y}Co_{1-x-y})O₂ [0<x+y<1]), NCA (Li(NiₓCo_{y}Al_{1-x-y})O₂ [<x+y<1]), LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄. Further, solid solutions obtained by substituting some of the atoms in a crystal of any of these lithium composite metal oxides with a typical metal, an alkali metal, an alkaline earth metal, a lanthanoid, a chalcogenide, a halogen, or the like are also included in the lithium composite metal oxide, and any of these solid solutions can also be used as the positive electrode active material 11. In this embodiment, particles of lithium cobalt oxide (LiCoO₂) are used as the positive electrode active material 11 because a high lithium ion conductivity is obtained.

From the viewpoint of bringing the particles of the positive electrode active material 11 into contact with one another so as to exhibit the electron conduction property, the particle diameter of the positive electrode active material 11 is preferably such that, for example, the average particle diameter D50 is set to 500 nm or more and less than 10 μm. Note that in FIG. 2, the shape of the particle of the positive electrode active material 11 is a spherical shape, however, the actual shape of the particle is not necessarily a spherical shape, and each particle has an indefinite shape.

A detailed method for forming the positive electrode composite 10 will be described later, but other than a green sheet method, a press sintering method, and the like can be exemplified. When a green sheet method or a press sintering method is used, if the solid electrolyte 12 is made to exist between the particles of the positive electrode active material 11 after sintering, the contact area between the positive electrode active material 11 in a particulate shape and the solid electrolyte 12 increases, and thus, the interfacial impedance of the positive electrode composite 10 can be decreased. The lithium-ion battery 100 of this embodiment is small and thin, and therefore, in consideration of the interfacial impedance of the positive electrode composite 10, the bulk density of the positive electrode active material 11 in the positive electrode composite 10 is preferably from 40% to 60%, and the bulk density of the solid electrolyte 12 is also preferably from 40% to 60%. Although the solid electrolyte 12 of this embodiment will be described in detail later, in the solid electrolyte 12, a garnet-type lithium composite metal oxide that conducts lithium is used, and the solid electrolyte 12 is in a particulate shape having an average particle diameter smaller than that of the positive electrode active material 11. Therefore, an interfacial impedance, that is, a grain boundary resistance also exists between the solid electrolyte particles constituting the solid electrolyte 12, however, the average particle diameter is small, and thus, the grain boundary resistance becomes low so that the solid electrolyte 12 is in a state where electric charges easily move.

In the lithium-ion battery 100, in order to obtain excellent charge-discharge characteristics, a high lithium ion conductivity in the positive electrode composite 10 is required to be achieved. Therefore, it is an important issue not only as to what material is selected for the positive electrode active material 11, but also as to what configuration of the solid electrolyte 12 is used to form the positive electrode composite 10. In this embodiment, a lithium composite metal oxide having a high lithium ion conductivity is used as the solid electrolyte 12.

### 1-1-2. Garnet-Type Solid Electrolyte

The solid electrolyte 12 of this embodiment is a lithium composite metal oxide having a garnet-type crystal structure or a garnet-like crystal structure that is represented by the following compositional formula (1) and conducts lithium.

Li₇₋ₓLa₃(Zr₂₋ₓMₓ)O₁₂ (1)

In the compositional formula, the element M is two or more types of elements selected from Nb, Ta, and Sb, and x satisfies 0.0<x<2.0.

According to the paper “First-Principles studies on cation dopants and electrolyte/cathode interphases for lithium garnets”, which was submitted by 4 people: Lincoln J. Miara, Willam Davidson Richards, Yan E. Wang, and Gerbrand Ceder to “Chemical of Materials” issued on Apr. 30, 2015 and published by the American Chemical Society, as an element (Dopant) that can substitute a Zr site in a garnet-type crystal structure, Mg, Sc, Ti, Hf, V, Nb, Ta, Ce, Th, Cr, Mo, W, Pa, Mn, Tc, Ru, Np, Co, Rh, Ir, Pu, Ni, Pd, Pt, Eu, Cu, Au, Cd, Hg, In, Tl, C, Si, Ge, Sn, Pb, As, Sb, S, Se, Te, Cl, and I are exemplified. In this embodiment, from the viewpoint of achieving a high lithium ion conductivity in the solid electrolyte 12, two or more types are selected from Nb, Ta, and Sb, each of which has a high permittivity and a small vacancy formation energy (E_{defect} (eV)) and can relatively easily substitute a Zr site among these elements.

According to such a lithium composite metal oxide, by partially substituting the Zr sites in the crystal structure with two or more types of elements selected from Nb, Ta, and Sb, in the below-mentioned method for producing the solid electrolyte 12, a high lithium ion conductivity can be achieved.

In the solid electrolyte 12, from the viewpoint of achieving a high lithium ion conductivity, the value x of the stoichiometric compositional ratio of the element M in the above compositional formula (1) is preferably within a range of 0.0<x<2.0. When x is 2.0 or more, the lithium ion conduction property is deteriorated. The details will be described in the below-mentioned section of Examples and Comparative Examples of the solid electrolyte 12.

### 1-1-3. Negative Electrode

As shown in FIG. 2, the negative electrode 30 as the electrode provided at one face 10b side of the positive electrode composite 10 of this embodiment is configured to include a negative electrode active material. As the negative electrode active material, any material may be used as long as it can repeat electrochemical occlusion and release of lithium ions at a lower potential than the material selected as the positive electrode active material 11. Specifically, Nb₂O₅, V₂O₅, TiO₂, In₂O₃, ZnO, SnO₂, NiO, ITO (Indium Tin Oxide), AZO (Al-doped Zinc Oxide), FTO (F-doped Tin Oxide), an anatase phase of TiO₂, lithium composite metal oxides such as Li₄Ti₅O₁₂ and Li₂Ti₃O₇, metals and alloys containing such a metal such as Li, Si, Sn, Si—Mn, Si—Co, Si—Ni, In, and Au, a carbon material, a material obtained by intercalation of lithium ions between layers of a carbon material, and the like can be exemplified. The alloy is not particularly limited as long as it can occlude and release lithium, but is preferably an alloy containing any of metal or metalloid elements in groups 13 and 14 excluding carbon, more preferably a metal simple substance such as aluminum, silicon, or tin, or an alloy or a compound containing such an atom. These may be used alone or two or more types thereof may be used in any combination at any ratio. As the alloy, lithium alloys such as Li—Al, Li—Ni, Li—Si, Li—Sn, and Li—Sn—Ni, silicon alloys such as Si—Zn, tin alloys such as Sn—Mn, Sn—Co, Sn—Ni, Sn—Cu, and Sn—La, Cu₂Sb, La₃Ni₂Sn₇, and the like can be exemplified.

In consideration of the discharge capacity of the lithium-ion battery 100 that is small and thin of this embodiment, the negative electrode 30 is preferably metal lithium (metal Li) or a metal simple substance and an alloy that form a lithium alloy.

As a method for forming the negative electrode 30 using the above-mentioned negative electrode active material, other than a solution process such as a so-called sol-gel method or an organometallic thermal decomposition method involving a hydrolysis reaction or the like of an organometallic compound, any method such as a CVD method using an appropriate metal compound in an appropriate gas atmosphere, an ALD method, a green sheet method or a screen printing method using a slurry of a solid negative electrode active material, an aerosol deposition method, a sputtering method using an appropriate target and an appropriate gas atmosphere, a PLD method, a vacuum vapor deposition method, a plating method, or a thermal spraying method may be used. In this embodiment, metal Li is deposited on the electrolyte layer 20 by a sputtering method, thereby forming the negative electrode 30.

### 1-1-4. Electrolyte Layer

As shown in FIG. 2, the electrolyte layer 20 is provided between the positive electrode composite 10 and the negative electrode 30. When metal Li is used as the negative electrode 30 as described above, lithium ions are released from the negative electrode 30 during discharging of the lithium-ion battery 100. Further, during charging of the lithium-ion battery 100, lithium ions are deposited as a metal on the negative electrode 30 and a dendritic crystal called dendrite is formed. When the dendrite is grown and comes in contact with the positive electrode active material 11 of the positive electrode composite 10, a short circuit occurs between the positive electrode composite 10 that functions as a positive electrode and the negative electrode 30. In order to prevent this short circuit, the electrolyte layer 20 is provided between the positive electrode composite 10 and the negative electrode 30. The electrolyte layer 20 is a layer composed of an electrolyte that does not include the positive electrode active material 11. For such an electrolyte layer 20, a crystalline material or an amorphous material composed of a metal compound such as an oxide, a sulfide, a halide, a nitride, a hydride, or a boride can be used.

Examples of an oxide crystalline material can include Li_{0.35}La_{0.55}TiO₃, Li_{0.2}La_{0.27}NbO₃, and a perovskite-type crystal or a perovskite-like crystal in which the elements of a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements of a crystal thereof are partially substituted with N, F, Al, Sr, Sc, Nb, Ta, Sb, a lanthanoid element, or the like, Li_{1.3}Ti_{1.7}Al_{0.3}(PO₄)₃, Li_{1.4}Al_{0.4}Ti_{1.6}(PO₄)₃, Li_{1.4}Al_{0.4}Ti_{1.4}Ge_{0.2}(PO₄)₃, and a NASICON-type crystal in which the elements of a crystal thereof are partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a sulfide crystalline material can include Li₁₀GeP₂S₁₂, Li_{9.6}P₃S₁₂, Li_{9.54}Si_{1.74}P_{1.44}S_{11.7}Cl_{0.3}, and Li₃PS₄.

Further, examples of other amorphous materials can include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

Note that the electrolyte layer 20 may be constituted using a garnet-type lithium composite metal oxide constituting the above-mentioned solid electrolyte 12. According to this, the interfacial impedance at the interface between the positive electrode composite 10 and the electrolyte layer 20 is decreased, and the lithium-ion battery 100 having a lower internal resistance can be achieved.

Further, when the electrolyte layer 20 is a crystalline material, the crystalline material preferably has a crystal structure such as a cubic crystal having small crystal plane anisotropy in lithium ion conduction. Further, when the electrolyte layer 20 is an amorphous material, the anisotropy in lithium ion conduction is small, and therefore, such a crystalline material or an amorphous material is preferred as a solid electrolyte constituting the electrolyte layer 20.

The thickness of the electrolyte layer 20 is preferably 0.1 μm or more and 100 μm or less, and more preferably 0.2 μm or more and 10 μm or less. By setting the thickness of the electrolyte layer 20 within the above range, the internal resistance of the electrolyte layer 20 can be decreased, and also the occurrence of a short circuit between the positive electrode composite 10 and the negative electrode 30 can be suppressed.

Note that in the face that comes in contact with the negative electrode 30 of the electrolyte layer 20, a relief structure of a trench, a grating, a pillar, or the like may be provided by combining various molding methods and processing methods as needed.

### 1-1-5. Current Collector

As shown in FIG. 2, the lithium-ion battery 100 includes a current collector 41 in contact with the other face 10a of the positive electrode composite 10 and a current collector 42 in contact with the negative electrode 30. The current collectors 41 and 42 are each an electric conductor provided so as to play a role in electron transfer to the positive electrode composite 10 or the negative electrode 30, and a material that has a sufficiently small electrical resistance and does not change the electric conduction property or the mechanical structure thereof by charging and discharging is selected. For example, one type of metal (metal simple substance) selected from the metal group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), an alloy composed of two or more types of metals selected from the metal group, or the like is used.

In this embodiment, aluminum is used as the current collector 41 at the positive electrode composite 10 side, and copper is used as the current collector 42 at the negative electrode 30 side. The thickness of each of the current collectors 41 and 42 is, for example, from 20 μm to 40 μm. Note that the lithium-ion battery 100 need only include one current collector of the pair of current collectors 41 and 42. For example, when multiple lithium-ion batteries 100 are stacked so as to be electrically coupled to one another in series and used, the lithium-ion battery 100 may also be configured to include only the current collector 41 of the pair of current collectors 41 and 42.

### 1-2. Precursor Solution of Garnet-Type Solid Electrolyte

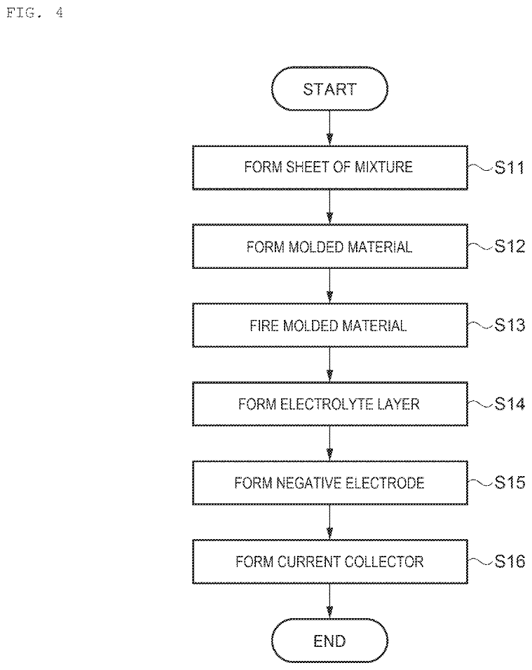

Next, the precursor solution of a garnet-type solid electrolyte of this embodiment will be described with reference to FIG. 3. FIG. 3 is a flowchart showing a method for producing a precursor solution of a garnet-type solid electrolyte of this embodiment.

As shown in FIG. 3, the method for producing a precursor solution of a garnet-type solid electrolyte of this embodiment includes a step of preparing raw material solutions containing elements shown in the following compositional formula (1) (Step S1), a step of preparing a mixed solution by mixing the raw material solutions containing the respective elements based on the following compositional formula (1) (Step S2), and a step of removing moisture from the mixed solution (Step S3).

Li₇₋ₓLa₃(Zr₂₋ₓMₓ)O₁₂ (1)

In the compositional formula, the element M is two or more types of elements selected from Nb, Ta, and Sb, and x satisfies 0.0<x<2.0.

In Step S1, raw material solutions containing Li, La, Zr, and the element M that are elements included in the above compositional formula (1) are prepared for each element. Specifically, each raw material solution is prepared so as to contain 1 mol (mole) of each element per kg of the raw material solution. The sources of the elements in the raw material solutions are a lithium compound, a lanthanum compound, a zirconium compound, and a compound containing the element M, each of which can be dissolved in one type of organic solvent. As such element compounds, metal salts or metal alkoxides of the elements are selected.

Examples of the lithium compound (lithium source) include lithium metal salts such as lithium chloride, lithium nitrate, lithium acetate, lithium hydroxide, and lithium carbonate, and lithium alkoxides such as lithium methoxide, lithium ethoxide, lithium propoxide, lithium isopropoxide, lithium butoxide, lithium isobutoxide, lithium sec-butoxide, lithium tert-butoxide, and lithium dipivaloylmethanate, and among these, one type can be used or two or more types can be used in combination.

Examples of the lanthanum compound (lanthanum source) include lanthanum metal salts such as lanthanum chloride, lanthanum nitrate, and lanthanum acetate, and lanthanum alkoxides such as lanthanum trimethoxide, lanthanum triethoxide, lanthanum tripropoxide, lanthanum triisopropoxide, lanthanum tributoxide, lanthanum triisobutoxide, lanthanum tri-sec-butoxide, lanthanum tri-tert-butoxide, and lanthanum dipivaloylmethanate, and among these, one type can be used or two or more types can be used in combination.

Examples of the zirconium compound (zirconium source) include zirconium alkoxides such as zirconium tetramethoxide, zirconium tetraethoxide, zirconium tetrapropoxide, zirconium tetraisopropoxide, zirconium tetrabutoxide, zirconium tetraisobutoxide, zirconium tetra-sec-butoxide, zirconium tetra-tert-butoxide, and zirconium dipivaloylmethanate, and among these, one type can be used or two or more types can be used in combination.

As the element M, two or more types are selected from Nb, Ta, and Sb, and a niobium compound, a tantalum compound, and an antimony compound are used.

Examples of the niobium compound (niobium source) include niobium metal salts such as niobium chloride, niobium oxychloride, and niobium oxalate, niobium alkoxides such as niobium pentaethoxide, niobium pentapropoxide, niobium pentaisopropoxide, and niobium penta-sec-butoxide, and niobium pentaacetylacetonate, and among these, one type can be used or two or more types can be used in combination.

Examples of the tantalum compound (tantalum source) include tantalum metal salts such as tantalum chloride and tantalum bromide, and tantalum alkoxides such as tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide, and among these, one type can be used or two or more types can be used in combination.

Examples of the antimony compound (antimony source) include antimony metal salts such as antimony bromide, antimony chloride, and antimony fluoride, and antimony alkoxides such as antimony trimethoxide, antimony triethoxide, antimony triisopropoxide, antimony tri-n-propoxide, antimony triisobutoxide, and antimony tri-n-butoxide, and among these, one type can be used or two or more types can be used in combination.

It is preferred that as the lithium source, a lithium metal salt compound is used, as the lanthanum source, a lanthanum metal salt compound is used, as the zirconium source, a zirconium alkoxide is used, and as the compound containing the element M, an alkoxide of the element M is used. According to this, the solubility in the below-mentioned organic solvent can be ensured.

Further, it is preferred that the lithium metal salt compound and the lanthanum metal salt compound are nitrates. According to this, the raw material solutions contain a nitrate, and in a process of sintering an oxide to become the solid electrolyte 12 in the below-mentioned method for producing the lithium-ion battery 100, the nitrate acts as a melt, and the interface between the positive electrode active material 11 and the solid electrolyte 12 is formed in a more organized manner.

Further, when the above-mentioned alkoxides are used as the zirconium compound and the compound containing the element M, it is preferred that the alkoxides have 4 or more and 8 or less carbon atoms or have a boiling point of 300° C. or higher. Specific examples of the alkoxides are exemplified and the relationship between the number of carbon atoms and the boiling point is shown in the following Table 1 and Table 2. Table 1 shows examples of the alkoxides of zirconium (Zr) and niobium (Nb), and Table 2 shows examples of the alkoxides of tantalum (Ta) and antimony (Sb).

TABLE 1

| | | |
|---|---|---|
| | Number of | |
| Substance name | carbon atoms | Boiling point |

[Zirconium alkoxide (Zr(O—CₙH₂ₙ₊₁)ₘ)]

| | | |
|---|---|---|
| Zirconium tetraethoxide | 2 | 235° C./666 Pa |
| | | (≈420° C.) |
| Zirconium tetraisopropoxide | 3 | 160° C./13.3 Pa |
| | | (≈420° C.) |
| Zirconium tetra-n-propoxide | 3 | 208° C./13.3 Pa |
| | | (≈490° C.) |
| Zirconium tetra-n-butoxide | 4 | 260° C./13.3 Pa |
| | | (≈555° C.) |
| Zirconium tetra-tert-butoxide | 4 | 30° C./13.3 Pa |
| | | (≈230° C.) |
| Zirconium tetra(2-ethylhexoxide) | 8 | >300° C. |

[Niobium alkoxide (Nb(O—CₙH₂ₙ₊₁)ₘ)]

| | | |
|---|---|---|
| Niobium pentamethoxide | 1 | 200° C./0.73 kPa |
| | | (≈370° C.) |
| Niobium pentaethoxide | 2 | 133° C./13.3 Pa |
| | | (≈380° C.) |
| Niobium penta-n-butoxide | 4 | 230° C./0.73 kPa |
| | | (≈405° C.) |
| Niobium penta-sec-butoxide | 4 | 112° C./13.3 Pa |
| | | (≈350° C.) |
| Niobium penta(2-ethylhexoxide) | 8 | >300° C. |

TABLE 2

| | | |
|---|---|---|
| | Number of | |
| Substance name | carbon atoms | Boiling point |

[Tantalum alkoxide (Ta(O—CₙH₂ₙ₊₁)ₘ)]

| | | |
|---|---|---|
| Tantalum pentamethoxide | 1 | 189° C./1333 Pa |
| | | (≈340° C.) |
| Tantalum pentaethoxide | 2 | 145° C./133 Pa |
| | | (≈350° C.) |
| Tantalum pentaisopropoxide | 3 | 122° C./13 Pa |
| | | (≈365° C.) |
| Tantalum penta-n-propoxide | 3 | 232° C./1333 Pa |
| | | (≈390° C.) |
| Tantalum penta-n-butoxide | 4 | 256° C./1333 Pa |
| | | (≈420° C.) |
| Tantalum penta-sec-butoxide | 4 | 156° C./733.3 Pa |
| | | (≈310° C.) |

[Antimony alkoxide (Sb(O—CₙH₂ₙ₊₁)ₘ)]

| | | |
|---|---|---|
| Antimony tri-n-butoxide | 4 | 134° C./0.8 kPa |
| | | (≈285° C.) |
| Antimony triisobutoxide | 4 | 144° C./4 kPa |
| | | (≈275° C.) |
| Antimony penta-n-butoxide | 4 | 217° C./20 Pa |
| | | (≈490° C.) |
| Antimony tri(2-ethylhexoxide) | 8 | >300° C. |

Note that in the above Table 1 and Table 2, the temperature (° C.)/pressure (Pa) in the column of the boiling point indicates the vapor pressure at the temperature of the substance, and the boiling point (° C.) at 1 atm of the substance shown in the parentheses is a value obtained by the boiling point conversion chart shown in Science of Petroleum, Vol. II. P. 1281 (1938).

As shown in the above Table 1 and Table 2, there exists an alkoxide having a boiling point of 300° C. or higher even if the number of carbon atoms is less than 4. Further, there exists an alkoxide having a boiling point lower than 300° C. even if the number of carbon atoms is 4 or more and 8 or less.

An alkoxide having less than 4 carbon atoms shows hydrophilicity and tends to cause a condensation reaction through moisture, and there is a fear that a byproduct is generated during sintering of the oxide. On the other hand, when an alkoxide has more than 8 carbon atoms, the solubility of the alkoxide in the organic solvent decreases. When an alkoxide has a boiling point lower than 300° C., the alkoxide is easily volatilized by heating, and there is a fear that the composition of the solid electrolyte 12 is affected. All the alkoxides illustrated in Table 1 and Table 2 can be used, however, as the zirconium alkoxide, it is preferred to use zirconium tetra-n-butoxide having 4 carbon atoms or zirconium tetra (2-ethylhexoxide) having 8 carbon atoms among the alkoxides illustrated in Table 1. As the niobium alkoxide, it is preferred to use niobium penta-n-butoxide or niobium penta-sec-butoxide having 4 carbon atoms or niobium penta (2-ethylhexoxide) having 8 carbon atoms among the alkoxides illustrated in Table 1. As the tantalum alkoxide, it is preferred to use tantalum penta-n-butoxide or tantalum penta-sec-butoxide having 4 carbon atoms among the alkoxides illustrated in Table 2. Similarly, as the antimony alkoxide, it is preferred to use antimony penta-n-butoxide having 4 carbon atoms or antimony tri(2-ethylhexoxide) having 8 carbon atoms among the alkoxides illustrated in Table 2.

In this manner, by selecting an alkoxide having 4 or more and 8 or less carbon atoms or having a boiling point of 300° C. or higher, the solid electrolyte 12 represented by the above compositional formula (1) can be reliably obtained.

It is preferred that the one type of organic solvent in which the lithium compound, the lanthanum compound, the zirconium compound, and the compound containing the element M are dissolved is nonaqueous. Specific examples thereof include alcohols such as n-butyl alcohol and ethylene glycol monobutyl ether (2-n-butoxyethanol), glycols such as butylene glycol, hexylene glycol, pentanediol, hexanediol, and heptanediol, aromatic solvents such as toluene, o-(ortho)-xylene, and p- (para)-xylene, and aliphatic solvents such as hexane, heptane, and octane. The nonaqueous organic solvent is not easily dissolved in water and hardly contains moisture. By using the nonaqueous organic solvent, even if metal salt compounds are used as the lithium compound and the lanthanum compound, the metal salts can be prevented from acting as acids due to dissolution of the metal salts in water to cause ion dissociation. The other element compounds can be prevented from being eroded by the acids derived from the metal salts.

In Step S2, a mixed solution is prepared by mixing at least 5 types of raw material solutions prepared in Step S1 according to the compositional ratio of elements in the above compositional formula (1). The mass of the raw material solution of the lithium compound in the mixed solution depends on the sintering temperature when synthesizing the solid electrolyte 12 in the below-mentioned method for producing a garnet-type solid electrolyte, and is preferably increased to 1.05 times or more and 1.20 times or less with respect to the stoichiometric composition represented by the compositional formula (1) in consideration of the amount of lithium volatilized and lost by sintering. The mass of each of the raw material solutions of the lanthanum compound, the zirconium compound, and the compound containing the element M other than the lithium compound is prepared equal (1.0 times) with respect to the stoichiometric composition represented by the compositional formula (1). Note that the preparation of the mixed solution is preferably performed in a dry atmosphere so as not to be affected by moisture. The dry atmosphere refers to an atmosphere containing dehumidified air or dehumidified inert gas such as nitrogen.

In Step S3, the mixed solution obtained in Step S2 is placed in, for example, a container such as a reagent bottle, a magnetic stirring bar is placed therein, and a dehydration of removing moisture from the mixed solution is performed by heating and stirring on a hot plate with a magnetic stirrer function. The set temperature of the hot plate at that time is set to a temperature that is higher than the boiling point of water and lower than the boiling point of the organic solvent contained in the mixed solution. The boiling point of the mixed solution containing moisture becomes lower than the boiling point of the organic solvent itself, and therefore, the organic solvent and water form an azeotropic mixture and dehydration can be performed at a temperature lower than the boiling point of the organic solvent by itself. The rotational speed of the magnetic stirring bar in stirring is, for example, 500 rpm. Further, the dehydration is performed until the amount of moisture contained in the mixed solution becomes 10 ppm or less. Note that it is preferred to supplement the organic solvent evaporated and lost by heating and stirring during the dehydration in consideration of the solubility of the lithium compound, the lanthanum compound, the zirconium compound, and the compound containing the element M in the organic solvent.

The mixed solution subjected to the dehydration in this manner is the precursor solution of a solid electrolyte of this embodiment. That is, the precursor solution of a solid electrolyte of this embodiment contains one type of organic solvent, and a lithium compound, a lanthanum compound, a zirconium compound, and a compound containing the element M, each of which has solubility in the organic solvent. Further, with respect to the stoichiometric composition of the above compositional formula (1), the lithium compound is contained in an amount 1.05 times or more and 1.20 times or less by mass, and the lanthanum compound, the zirconium compound, and the compound containing the element M are each contained in an amount equal (1.0 times) by mass. Further, by setting the amount of moisture contained in the precursor solution of a solid electrolyte to 10 ppm or less, the mixed solution containing the respective raw material solutions of the lithium source, the lanthanum source, the zirconium source, and the element M source is prevented from being deteriorated due to moisture, and the precursor solution of a solid electrolyte having excellent storage stability for a long period of time is formed.

### 1-3. Method for Producing Garnet-Type Solid Electrolyte

An example of a method for producing the garnet-type solid electrolyte 12 will be described. First, the precursor solution of a solid electrolyte of this embodiment described above is placed in, for example, a dish made of titanium, and subjected to a first heating treatment at, for example, 50° C. to 250° C. on a hot plate to remove the solvent component from the precursor solution of a solid electrolyte, thereby obtaining a mixture. Subsequently, the mixture is subjected to a second heating treatment at, for example, 400° C. to 550° C. for about 30 minutes to 2 hours in an oxidative atmosphere to completely burn the solvent component, thereby oxidizing the mixture to form an oxide. Further, the oxide is transferred to an agate mortar and sufficiently ground, and then, the resultant is placed in, for example, a crucible made of magnesium oxide, and sintered by performing a third heating treatment at 800° C. or higher and 1000° C. or lower in the air for about 4 hours to 10 hours, whereby the solid electrolyte 12 represented by the above compositional formula (1) is obtained. That is, the solid electrolyte 12 is a sintered body. When the third heating treatment of performing sintering of the oxide is defined as main firing, the second heating treatment of oxidizing the mixture to obtain the oxide is calcination, and the oxide is a calcined body.

### 1-4. Method for Producing Lithium-Ion Battery

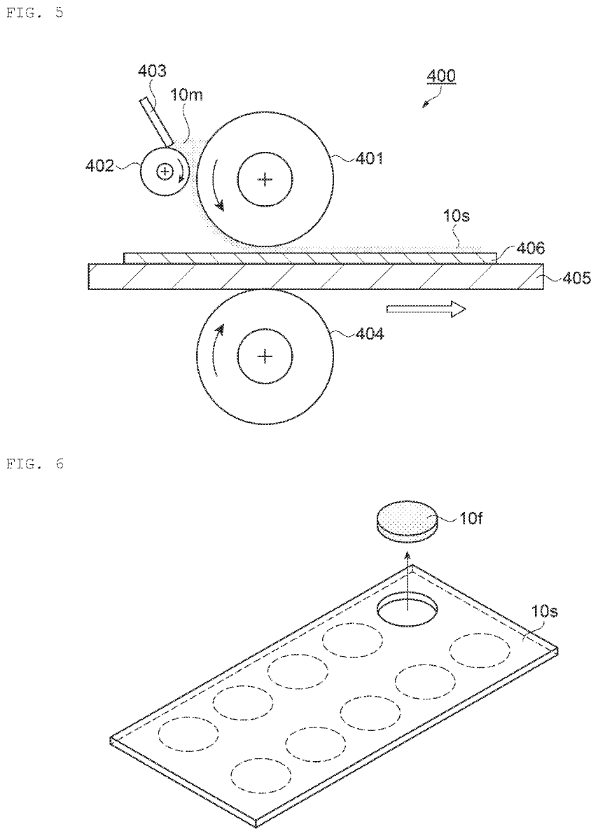

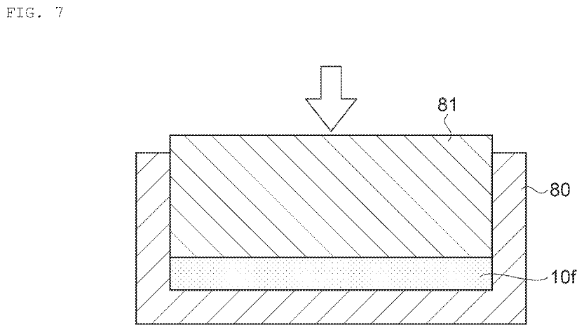

Next, an example of a method for producing the lithium-ion battery 100 of this embodiment will be described with reference to FIGS. 4 to 6. FIG. 4 is a flowchart showing the method for producing a lithium-ion battery of this embodiment. FIGS. 5 and 6 are each a schematic view showing a step in the method for producing a lithium-ion battery of this embodiment.

As shown in FIG. 4, an example of the method for producing the lithium-ion battery 100 of this embodiment includes a step of forming a sheet of a mixture containing the solid electrolyte 12 formed using the precursor solution of a solid electrolyte of this embodiment (Step S11), a step of forming a molded material using the sheet of the mixture (Step S12), and a step of firing the molded material (Step S13). Step S11 to Step S13 so far are steps showing a method for forming the positive electrode composite 10. Then, the method includes a step of forming the electrolyte layer 20 for the obtained positive electrode composite 10 (Step S14), a step of forming the negative electrode 30 (Step S15), and a step of forming the current collectors 41 and 42 (Step S16).

In the step of forming a sheet of a mixture of Step S11, first, the positive electrode active material 11 in a particulate shape, a powder of the solid electrolyte 12 of this embodiment, a solvent, and a binder are mixed, whereby a slurry 10m as the mixture is prepared. The mass ratios of the respective materials in the slurry 10m are, for example, 40% for the positive electrode active material 11, 10% for the binder, 40% for the solid electrolyte 12, and the remainder is the solvent. Subsequently, as shown in FIG. 5, for example, by using a fully automatic film applicator 400, the slurry 10m is applied to a fixed thickness on a base material 406 such as a polyethylene terephthalate (PET) film, whereby a positive electrode composite mixture sheet 10s is formed. The fully automatic film applicator 400 includes an application roller 401 and a doctor roller 402. A squeegee 403 is provided so as to come in contact with the doctor roller 402 from above. A conveyance roller 404 is provided below the application roller 401 at a position opposite thereto, and a stage 405 on which the base material 406 is placed is conveyed in a fixed direction by inserting the stage 405 between the application roller 401 and the conveyance roller 404. The slurry 10m is fed to a side at which the squeegee 403 is provided between the application roller 401 and the doctor roller 402 disposed with a gap therebetween in the conveyance direction of the stage 405. The slurry 10m with a fixed thickness is applied to the surface of the application roller 401 by rotating the application roller 401 and the doctor roller 402 so as to extrude the slurry 10m downward from the gap. Then, by simultaneously rotating the conveyance roller 404, the stage 405 is conveyed so that the base material 406 comes in contact with the application roller 401 having the slurry 10m applied thereto. By doing this, the slurry 10m applied to the application roller 401 is transferred in a sheet form to the base material 406, whereby the positive electrode composite mixture sheet 10s is formed. The thickness of the positive electrode composite mixture sheet 10s at that time is, for example, from 175 μm to 225 μm. Note that in Step S11, the positive electrode composite mixture sheet 10s having a fixed thickness is formed by pressing and extruding the slurry 10m by the application roller 401 and the doctor roller 402 so that the volume density of the positive electrode active material 11 in the positive electrode composite 10 obtained after firing becomes 50% or more.

Subsequently, by heating the base material 406 having the positive electrode composite mixture sheet 10s formed thereon, the solvent component is removed from the positive electrode composite mixture sheet 10s to harden the sheet. The heating temperature at that time is, for example, 50° C. or higher and 250° C. or lower. After hardening, the positive electrode composite mixture sheet 10s is detached from the base material 406. Then, the process proceeds to Step S12.

In the step of forming a molded material of Step S12, by punching out the positive electrode composite mixture sheet 10s using a punching die made to correspond to the shape of the positive electrode composite 10, a molded material 10f having a circular disk shape is taken out as shown in FIG. 6. Multiple molded materials 10f can be taken out from one positive electrode composite mixture sheet 10s. Then, the process proceeds to Step S13.

In the step of firing the molded material of Step S13, the molded material 10f is placed in, for example, a crucible made of magnesium oxide, and the crucible is placed in an electric muffle furnace, and firing is performed at a temperature lower than the melting point of the positive electrode active material 11, whereby the molded material 10f is sintered. By the firing, the binder is removed, and also the positive electrode composite 10 in which the positive electrode active materials 11 are sintered in a state of being in contact with one another is obtained. The positive electrode composite 10 is in a state where the solid electrolyte 12 is present between the positive electrode active materials 11 in a particulate shape in contact with each other therein (see FIG. 2). The thickness of the positive electrode composite 10 obtained after sintering is about 150 μm to 200 μm. Then, the process proceeds to Step S14.

In the step of forming an electrolyte layer of Step S14, the electrolyte layer 20 is formed for the positive electrode composite 10. In this embodiment, for example, LIPON (Li_{2.9}PO_{3.3}N_{0.46}) that is an amorphous electrolyte was deposited by a sputtering method, whereby the electrolyte layer 20 was formed. The thickness of the electrolyte layer 20 is, for example, 2 μm. Then, the process proceeds to Step S15.

In the step of forming a negative electrode of Step S15, the negative electrode 30 is formed by being stacked on the electrolyte layer 20. As a method for forming the negative electrode 30, as described above, various methods such as a solution process can be used, however, in this embodiment, metal Li was deposited for the electrolyte layer 20 by a sputtering method, whereby the negative electrode 30 was formed. The thickness of the negative electrode 30 is, for example, 20 μm. Then, the process proceeds to Step S16.

In the step of forming a current collector of Step S16, as shown in FIG. 2, the current collector 41 is formed in contact with the other face 10a of the positive electrode composite 10. Further, the current collector 42 is formed in contact with the negative electrode 30. In this embodiment, for example, an aluminum foil having a thickness of 20 μm was used, and the aluminum foil was disposed in pressure-contact with a forming face, whereby the current collector 41 was formed. In addition, for example, a copper foil having a thickness of μm was used, and the copper foil was disposed in pressure-contact with a forming face, whereby the current collector 42 was formed. By doing this, the lithium-ion battery 100 in which the positive electrode composite 10, the electrolyte layer 20, and the negative electrode 30 are sequentially stacked between the pair of current collectors 41 and 42 is obtained. Note that the current collector 41 may be formed in contact with the positive electrode composite 10 after Step S13.

In the method for producing the lithium-ion battery 100 described above, the slurry 10m is formed by mixing the positive electrode active material 11 in a particulate shape, a powder of the solid electrolyte 12, a solvent, and a binder, however, the method for forming the slurry 10m is not limited thereto. For example, the slurry 10m may be formed by mixing the positive electrode active material 11 in a particulate shape and the precursor solution of a solid electrolyte of this embodiment. According to this, the solvent or the binder can be dispensed with. Further, the precursor solution of a solid electrolyte is a liquid, and therefore, as compared to a case where a powder of the solid electrolyte 12 is used, the positive electrode active material 11 in a particulate shape and the precursor solution of a solid electrolyte can be homogeneously mixed. Therefore, the solid electrolyte 12 can be evenly disposed in a void generated by mutual contact of the positive electrode active materials 11 in a particulate shape after firing in Step S13, and thus, the contact area between the positive electrode active material 11 and the solid electrolyte 12 can be maximized. Further, the amount of moisture contained in the precursor solution of a solid electrolyte is limited to 10 ppm or less, and even if metal salt compounds are used as the lithium compound and the lanthanum compound, generation of acids derived from the metal salts is suppressed, and therefore, the composition can be prevented from being changed due to erosion of the positive electrode active material 11 by the acids. In addition, the generation of acids derived from the metal salts is suppressed, and therefore, the well-organized formation of an interface between the positive electrode active material 11 and the solid electrolyte 12 is not inhibited by the acids. Accordingly, the contact area between the positive electrode active material 11 and the solid electrolyte 12 is ensured, and desired battery performance is achieved.

Further, in the step of forming an electrolyte layer of Step S14, the electrolyte layer 20 is formed for the positive electrode composite 10 by a sputtering method, however, the method for forming the electrolyte layer 20 is not limited thereto. For example, a powder of the solid electrolyte 12 of this embodiment and a solvent are mixed to form a slurry, and the slurry is fed to the fully automatic film applicator 400 and formed into a solid electrolyte mixture sheet. The obtained solid electrolyte mixture sheet and the positive electrode composite mixture sheet 10s obtained in Step S11 are overlapped with each other and pressed with a pressure of, for example, 6 MPa, whereby a stacked body is formed. The stacked body is punched out to form a molded material. Thereafter, in the same manner as in the above-mentioned Step S13, the molded material is placed in, for example, a crucible made of magnesium oxide, and the crucible is placed in an electric muffle furnace, and firing is performed at a temperature lower than the melting point of the positive electrode active material 11, whereby the molded material is sintered. A stacked body in which the positive electrode composite 10 and the electrolyte layer 20 are stacked may be obtained in this manner. The electrolyte layer 20 is formed using the solid electrolyte 12 of this embodiment, and therefore, a stacked body in which the interfacial impedance at the interface between the positive electrode composite 10 and the electrolyte layer 20 is decreased is obtained.

Further, in the method for producing the lithium-ion battery 100 of this embodiment, the method for forming the positive electrode composite 10 by a green sheet method is illustrated, however, the method for forming the positive electrode composite 10 is not limited thereto. FIG. 7 is a schematic view showing another method for forming a positive electrode composite. For example, as shown in FIG. 7, a powder obtained by placing the solid electrolyte 12 of this embodiment in an agate mortar and well grinding it, the positive electrode active material 11 in a particulate shape, and a binder are well mixed and placed in a pellet die 80 with an exhaust port. Then, uniaxial press molding is performed from the lid 81 side, whereby the molded material 10f is obtained. Subsequently, the molded material 10f is placed in a crucible made of magnesium oxide, and the crucible is placed in an electric muffle furnace, and firing is performed at a temperature lower than the melting point of the positive electrode active material 11, whereby the positive electrode composite 10 may be obtained.

### 1-5. Examples and Comparative Examples of Solid Electrolyte

Next, with respect to solid electrolyte pellets formed using the precursor solution of a solid electrolyte of this embodiment, the evaluation results thereof will be described by showing specific Examples 1 to 10 and Comparative Examples 1 to 5.

First, respective raw material solutions of the lithium source, the lanthanum source, the zirconium source, and the niobium source, the tantalum source, and the antimony source as the element M used for producing solid electrolytes of Examples or Comparative Examples will be described. These raw material solutions are all prepared at a concentration of 1 mol/kg for facilitating weighing when a mixed solution is prepared by mixing the solutions.

### 2-n-Butoxyethanol Solution of Lithium Nitrate at 1 Mol/Kg

In a 30-g reagent bottle made of Pyrex (trademark of Corning Incorporated) equipped with a magnetic stirring bar, 1.3789 g of lithium nitrate with a purity of 99.95%, 3N₅, of Kanto Chemical Co., Inc. and 18.6211 g of 2-n-butoxyethanol (ethylene glycol monobutyl ether) Cica Special Grade of Kanto Chemical Co., Inc. were weighed. Then, the reagent bottle was placed on a hot plate with a magnetic stirrer function, and lithium nitrate was completely dissolved in 2-n-butoxyethanol while stirring at 170° C. for 1 hour, followed by slow cooling to about 20° C., whereby a 2-n-butoxyethanol solution of lithium nitrate at 1 mol/kg was obtained. Note that the purity of lithium nitrate can be measured using an ion chromatograph-mass spectrometer.

### 2-n-Butoxyethanol Solution of Lanthanum Nitrate Hexahydrate at 1 Mol/Kg

In a 30-g reagent bottle made of Pyrex equipped with a magnetic stirring bar, 8.6608 g of lanthanum nitrate hexahydrate, 4N, manufactured by Kanto Chemical Co., Inc. and 11.3392 g of 2-n-butoxyethanol Cica Special Grade of Kanto Chemical Co., Inc. were weighed. Then, the reagent bottle was placed on a hot plate with a magnetic stirrer function, and lanthanum nitrate hexahydrate was completely dissolved in 2-n-butoxyethanol while stirring at 140° C. for 30 minutes, followed by slow cooling to about 20° C., whereby a 2-n-butoxyethanol solution of lanthanum nitrate hexahydrate at 1 mol/kg was obtained.

### Preparation of 2-n-Butoxyethanol Solution of Zirconium Tetra-n-Butoxide at 1 Mol/Kg

In a 20-g reagent bottle made of Pyrex equipped with a magnetic stirring bar, 3.8368 g of zirconium tetra-n-butoxide manufactured by Kojundo Chemical Laboratory Co., Ltd. and 6.1632 g of 2-n-butoxyethanol Cica Special Grade of Kanto Chemical Co., Inc. were weighed. Then, the reagent bottle was placed on a hot plate with a magnetic stirrer function, and zirconium tetra-n-butoxide was completely dissolved in 2-n-butoxyethanol while stirring at about 20° C. for 30 minutes, whereby a 2-n-butoxyethanol solution of zirconium tetra-n-butoxide at 1 mol/kg was obtained.

### Preparation of 2,4-Pentanedione Solution of Zirconium Tetra-n-Butoxide at 1 Mol/Kg

In a 20-g reagent bottle made of Pyrex equipped with a magnetic stirring bar, 3.8368 g of zirconium tetra-n-butoxide manufactured by Kojundo Chemical Laboratory Co., Ltd. and 6.1632 g of 2,4-pentanedione Cica Special Grade of Kanto Chemical Co., Inc. were weighed. Then, the reagent bottle was placed on a hot plate with a magnetic stirrer function, and zirconium tetra-n-butoxide was completely dissolved in 2,4-pentanedione while stirring at about 20° C. for 30 minutes, whereby a 2,4-pentanedione solution of zirconium tetra-n-butoxide at 1 mol/kg was obtained.

### 2-n-Butoxyethanol Solution of Niobium Pentaethoxide at 1 Mol/Kg

In a 20-g reagent bottle made of Pyrex equipped with a magnetic stirring bar, 3.1821 g of niobium pentaethoxide, 4N, manufactured by Kojundo Chemical Laboratory Co., Ltd. and 6.8179 g of 2-n-butoxyethanol Cica Special Grade of Kanto Chemical Co., Inc. were weighed. Then, the reagent bottle was placed on a hot plate with a magnetic stirrer function, and niobium pentaethoxide was completely dissolved in 2-n-butoxyethanol while stirring at about 20° C. for 30 minutes, whereby a 2-n-butoxyethanol solution of niobium pentaethoxide at 1 mol/kg was obtained.

### Preparation of 2-n-Butoxyethanol Solution of Tantalum Pentaethoxide at 1 Mol/Kg

In a 20-g reagent bottle made of Pyrex equipped with a magnetic stirring bar, 4.0626 g of tantalum pentaethoxide, 5N, manufactured by Kojundo Chemical Laboratory Co., Ltd. and 5.9374 g of 2-n-butoxyethanol Cica Special Grade of Kanto Chemical Co., Inc. were weighed. Then, the reagent bottle was placed on a hot plate with a magnetic stirrer function, and tantalum pentaethoxide was completely dissolved in 2-n-butoxyethanol while stirring at about 20° C. for 30 minutes, whereby a 2-n-butoxyethanol solution of tantalum pentaethoxide at 1 mol/kg was obtained.

### Preparation of 2-n-Butoxyethanol Solution of Antimony Tri-n-Butoxide at 1 Mol/Kg

In a 20-g reagent bottle made of Pyrex equipped with a magnetic stirring bar, 3.4110 g of antimony tri-n-butoxide, manufactured by Wako Pure Chemical Industries, Ltd. and 6.5890 g of 2-n-butoxyethanol Cica Special Grade of Kanto Chemical Co., Inc. were weighed. Then, the reagent bottle was placed on a hot plate with a magnetic stirrer function, and antimony tri-n-butoxide was completely dissolved in 2-n-butoxyethanol while stirring at about 20° C. for 30 minutes, whereby a 2-n-butoxyethanol solution of antimony tri-n-butoxide at 1 mol/kg was obtained.

### 1-5-1. Production of Solid Electrolyte Pellet for Evaluation of Example 1

The solid electrolyte of Example 1 is a solid electrolyte, in which Nb and Ta are selected as the element M, and which is represented by the compositional formula: Li_{6.7}La₃(Zr_{1.7}Nb_{0.25}Ta_{0.05})O₁₂. That is, the value x of the compositional ratio of the element M is 0.25+0.05=0.3. Hereinafter, the precursor solution of a solid electrolyte is simply referred to as the precursor solution.

First, a 2-n-butoxyethanol precursor solution of the solid electrolyte represented by the compositional formula: Li_{6.7}La₃(Zr_{1.7}Nb_{0.25}Ta_{0.05})O₁₂ at 1 mol/kg of Example 1 is prepared. Specifically, in a reagent bottle made of Pyrex, 8.040 g of the 2-n-butoxyethanol solution of lithium nitrate at 1 mol/kg, 3.000 g of the 2-n-butoxyethanol solution of lanthanum nitrate hexahydrate at 1 mol/kg, and 2 mL (milliliters) of 2-n-butoxyethanol as the organic solvent are weighed, and a magnetic stirring bar is placed therein, and the reagent bottle is placed on a hot plate with a magnetic stirrer function. Then, since the boiling point of 2-n-butoxyethanol is 171° C., the set temperature of the hot plate is set to 160° C., and the rotation speed is set to 500 rpm, and heating and stirring are performed for 30 minutes. Subsequently, 2 ml of 2-n-butoxyethanol is added thereto, and heating and stirring are performed for 30 minutes again. When 30 minute-heating and stirring is regarded as a one-time dehydration, in Example 1, the dehydration is regarded as having been performed twice. After the dehydration, the reagent bottle is covered with a lid and hermetically sealed. Subsequently, stirring is performed by setting the set temperature of the hot plate to, for example, 25° C. that is the same temperature as room temperature and the rotation speed to 500 rpm, and the reagent bottle is slowly cooled to room temperature. Subsequently, the reagent bottle is transferred to a dry atmosphere, and in the reagent bottle, 1.700 g of the 2-n-butoxyethanol solution of zirconium tetra-n-butoxide at 1 mol/kg, 0.250 g of the 2-n-butoxyethanol solution of niobium pentaethoxide at 1 mol/kg, and 0.050 g of the 2-n-butoxyethanol solution of tantalum pentaethoxide at 1 mol/kg are weighed, and a magnetic stirring bar is placed therein. Subsequently, stirring was performed at room temperature for 30 minutes by setting the rotation speed of a magnetic stirrer to 500 rpm, whereby a precursor solution was obtained. Note that the preparation of the mass of the 2-n-butoxyethanol solution of lithium nitrate at 1 mol/kg depends on the sintering temperature of the main firing to be performed thereafter, and in Example 1, the sintering temperature is 900° C., and therefore, the mass is 8.040 g that is 1.20 times the compositional ratio of lithium represented by the above compositional formula. If the sintering temperature of the main firing is 800° C., the mass may be 7.035 g that is 1.05 times the compositional ratio of lithium represented by the above compositional formula. The mass of each of the raw material solutions of the lanthanum source, the zirconium source, the niobium source, and the tantalum source is equal to the compositional ratio of each element represented by the above compositional formula.

Subsequently, the precursor solution of Example 1 is placed in a dish made of titanium having an inner diameter of 50 mm and a height of 20 mm. This dish was placed on a hot plate and heated for 1 hour by setting the set temperature of the hot plate to 160° C., and then heated for 30 minutes by setting the set temperature to 180° C. to remove the solvent. Subsequently, the dish was heated for 30 minutes by setting the set temperature of the hot plate to 360° C. to decompose most of the contained organic component by combustion. Thereafter, the dish was heated for 1 hour by setting the set temperature of the hot plate to 540° C. to burn and decompose the remaining organic component. Thereafter, the dish was slowly cooled to room temperature on the hot plate, whereby a calcined body was obtained.

Subsequently, the calcined body was transferred to an agate mortar and sufficiently ground. 0.150 g of the powder of the calcined body was weighed and placed in a pellet die with an exhaust port having an inner diameter of 10 mm as a molding die, and then pressed with a pressure of 0.624 kN/mm² (624 MPa) for 5 minutes, whereby a calcined body pellet that is a circular disk-shaped molded material was produced.

Further, the calcined body pellet was placed in a crucible made of magnesium oxide, the crucible was covered with a lid made of magnesium oxide, and then, main firing was performed in an electric muffle furnace FP311 of Yamato Scientific Co., Ltd. The main firing conditions were set to 900° C. and 8 hours. Subsequently, the electric muffle furnace was slowly cooled to room temperature, and then, the solid electrolyte pellet for evaluation of Example 1 having a diameter of about 9.5 mm and a thickness of about 600 μm was taken out from the crucible.

### 1-5-2. Production of Solid Electrolyte Pellet for Evaluation of Example 2

The solid electrolyte of Example 2 is a solid electrolyte, in which Nb and Ta are selected as the element M, and which is represented by the compositional formula: Li_{6.7}La₃(Zr_{1.7}Nb_{0.25}Ta_{0.05})O₁₂ being the same as that of Example 1. That is, the value x of the compositional ratio of the element M is 0.3.

The method for producing a solid electrolyte pellet for evaluation of Example 2 is the same as that of Example 1 except that the main firing conditions are changed to 1000° C. and 8 hours from those of Example 1. That is, the dehydration for the precursor solution is performed twice. By using such a precursor solution of Example 2, the solid electrolyte pellet for evaluation of Example 2 was produced in the same manner as in Example 1.

### 1-5-3. Production of Solid Electrolyte Pellet for Evaluation of Example 3

The solid electrolyte of Example 3 is a solid electrolyte, in which Nb and Sb are selected as the element M, and which is represented by the compositional formula: Li_{6.35}La₃(Zr_{1.35}Nb_{0.25}Sb_{0.4})O₁₂. That is, the value x of the compositional ratio of the element M is 0.25+0.4=0.65.

A 2-n-butoxyethanol precursor solution of the solid electrolyte represented by the compositional formula: Li_{6.35}La₃(Zr_{1.35}Nb_{0.25}Sb_{0.4})O₁₂ at 1 mol/kg of Example 3 is prepared to contain 7.620 g of the 2-n-butoxyethanol solution of lithium nitrate at 1 mol/kg, 3.000 g of the 2-n-butoxyethanol solution of lanthanum nitrate hexahydrate at 1 mol/kg, 1.350 g of the 2-n-butoxyethanol solution of zirconium tetra-n-butoxide at 1 mol/kg, 0.250 g of the 2-n-butoxyethanol solution of niobium pentaethoxide at 1 mol/kg, 0.400 g of the 2-n-butoxyethanol solution of antimony n-butoxide at 1 mol/kg, and 2-n-butoxyethanol as the organic solvent. The method for preparing the precursor solution is basically the same as that of Example 1, and the main firing conditions are set to 900° C. and 8 hours, and therefore, the mass of the 2-n-butoxyethanol solution of lithium nitrate at 1 mol/kg is 7.620 g that is 1.20 times the compositional ratio of lithium represented by the above compositional formula. Further, the dehydration for the precursor solution is performed twice. By using such a precursor solution of Example 3, the solid electrolyte pellet for evaluation of Example 3 was produced in the same manner as in Example 1.

### 1-5-4. Production of Solid Electrolyte Pellet for Evaluation of Example 4

The solid electrolyte of Example 4 is a solid electrolyte, in which Nb and Sb are selected as the element M, and which is represented by the compositional formula: Li_{6.35}La₃(Zr_{1.35}Nb_{0.25}Sb_{0.4})O₁₂ being the same as that of Example 3. That is, the value x of the compositional ratio of the element M is 0.65.

The method for producing a solid electrolyte pellet for evaluation of Example 4 is the same as that of Example 3 except that the main firing conditions are changed to 1000° C. and 8 hours from those of Example 3. That is, the dehydration for the precursor solution is performed twice. By using such a precursor solution of Example 4, the solid electrolyte pellet for evaluation of Example 4 was produced in the same manner as in Example 1.

### 1-5-5. Production of Solid Electrolyte Pellet for Evaluation of Example 5

The solid electrolyte of Example 5 is a solid electrolyte, in which Sb and Ta are selected as the element M, and which is represented by the compositional formula: Li_{6.31}La₃(Zr_{1.3}Sb_{0.5}Ta_{0.2})O₁₂. That is, the value x of the compositional ratio of the element M is 0.5+0.2=0.7.

A 2-n-butoxyethanol precursor solution of the solid electrolyte represented by the compositional formula: Li_{6.3}La₃(Zr_{1.3}Sb_{0.5}Ta_{0.2})O₁₂ at 1 mol/kg of Example 5 is prepared to contain 7.560 g of the 2-n-butoxyethanol solution of lithium nitrate at 1 mol/kg, 3.000 g of the 2-n-butoxyethanol solution of lanthanum nitrate hexahydrate at 1 mol/kg, 1.300 g of the 2-n-butoxyethanol solution of zirconium tetra-n-butoxide at 1 mol/kg, 0.500 g of the 2-n-butoxyethanol solution of antimony n-butoxide at 1 mol/kg, 0.200 g of the 2-n-butoxyethanol solution of tantalum pentaethoxide at 1 mol/kg, and 2-n-butoxyethanol as the organic solvent. The method for preparing the precursor solution is basically the same as that of Example 1, and the main firing conditions are set to 900° C. and 8 hours, and therefore, the mass of the 2-n-butoxyethanol solution of lithium nitrate at 1 mol/kg is 7.560 g that is 1.20 times the compositional ratio of lithium represented by the above compositional formula. Further, the dehydration for the precursor solution is performed twice. By using such a precursor solution of Example 5, the solid electrolyte pellet for evaluation of Example 5 was produced in the same manner as in Example 1.

### 1-5-6. Production of Solid Electrolyte Pellet for Evaluation of Example 6

The solid electrolyte of Example 6 is a solid electrolyte, in which Sb and Ta are selected as the element M, and which is represented by the compositional formula: Li_{6.3}La₃(Zr_{1.3}Sb_{0.5}Ta_{0.2})O₁₂ being the same as that of Example 5. That is, the value x of the compositional ratio of the element M is 0.7.

The method for producing a solid electrolyte pellet for evaluation of Example 6 is the same as that of Example 5 except that the main firing conditions are changed to 1000° C. and 8 hours from those of Example 5. That is, the dehydration for the precursor solution is performed twice. By using such a precursor solution of Example 6, the solid electrolyte pellet for evaluation of Example 6 was produced in the same manner as in Example 1.

### 1-5-7. Production of Solid Electrolyte Pellet for Evaluation of Example 7

The solid electrolyte of Example 7 is a solid electrolyte, in which three types: Nb, Sb, and Ta are selected as the element M, and which is represented by the compositional formula: Li_{5.95}La₃(Zr_{0.95}Nb_{0.25}Sb_{0.4}Ta_{0.4})O₁₂. That is, the value x of the compositional ratio of the element M is 0.25+0.4+0.4=1.05.

A 2-n-butoxyethanol precursor solution of the solid electrolyte represented by the compositional formula: Li_{5.95}La₃(Zr_{0.95}Nb_{0.25}Sb_{0.4}Ta_{0.4})O₁₂ at 1 mol/kg of Example 7 is prepared to contain 7.140 g of the 2-n-butoxyethanol solution of lithium nitrate at 1 mol/kg, 3.000 g of the 2-n-butoxyethanol solution of lanthanum nitrate hexahydrate at 1 mol/kg, 0.950 g of the 2-n-butoxyethanol solution of zirconium tetra-n-butoxide at 1 mol/kg, 0.250 g of the 2-n-butoxyethanol solution of niobium pentaethoxide at 1 mol/kg, 0.400 g of the 2-n-butoxyethanol solution of antimony n-butoxide at 1 mol/kg, 0.400 g of the 2-n-butoxyethanol solution of tantalum pentaethoxide at 1 mol/kg, and 2-n-butoxyethanol as the organic solvent. The method for preparing the precursor solution is basically the same as that of Example 1, and the main firing conditions are set to 900° C. and 8 hours, and therefore, the mass of the 2-n-butoxyethanol solution of lithium nitrate at 1 mol/kg is 7.140 g that is 1.20 times the compositional ratio of lithium represented by the above compositional formula. Further, the dehydration for the precursor solution is performed twice. By using such a precursor solution of Example 7, the solid electrolyte pellet for evaluation of Example 7 was produced in the same manner as in Example 1.

### 1-5-8. Production of Solid Electrolyte Pellet for Evaluation of Example 8

The solid electrolyte of Example 8 is a solid electrolyte, in which three types: Nb, Sb, and Ta are selected as the element M, and which is represented by the compositional formula: Li_{5.95}La₃(Zr_{0.95}Nb_{0.25}Sb_{0.4}Ta_{0.4})O₁₂ being the same as that of Example 7. That is, the value x of the compositional ratio of the element M is 1.05.

The method for producing a solid electrolyte pellet for evaluation of Example 8 is the same as that of Example 7 except that the main firing conditions are changed to 1000° C. and 8 hours from those of Example 7. That is, the dehydration for the precursor solution is performed twice. By using such a precursor solution of Example 8, the solid electrolyte pellet for evaluation of Example 8 was produced in the same manner as in Example 1.

### 1-5-9. Production of Solid Electrolyte Pellet for Evaluation of Example 9

The solid electrolyte of Example 9 is a solid electrolyte, in which Sb and Ta are selected as the element M, and which is represented by the compositional formula: Li_{6.2}La₃(Zr_{1.2}Sb_{0.4}Ta_{0.4})O₁₂. The value x of the compositional ratio of the element M is 0.4+0.4=0.8. That is, in the solid electrolyte of Example 9, the configuration of the selected element M is the same as that of Example 5, but the value x of the compositional ratio of the element M is made different from that of Example 5.

A 2-n-butoxyethanol precursor solution of the solid electrolyte represented by the compositional formula: Li_{6.2}La₃(Zr_{1.2}Sb_{0.4}Ta_{0.4})O₁₂ at 1 mol/kg of Example 9 is prepared to contain 7.440 g of the 2-n-butoxyethanol solution of lithium nitrate at 1 mol/kg, 3.000 g of the 2-n-butoxyethanol solution of lanthanum nitrate hexahydrate at 1 mol/kg, 1.200 g of the 2-n-butoxyethanol solution of zirconium tetra-n-butoxide at 1 mol/kg, 0.400 g of the 2-n-butoxyethanol solution of antimony n-butoxide at 1 mol/kg, 0.400 g of the 2-n-butoxyethanol solution of tantalum pentaethoxide at 1 mol/kg, and 2-n-butoxyethanol as the organic solvent. The method for preparing the precursor solution is basically the same as that of Example 1, and the main firing conditions are set to 900° C. and 8 hours, and therefore, the mass of the 2-n-butoxyethanol solution of lithium nitrate at 1 mol/kg is 7.440 g that is 1.20 times the compositional ratio of lithium represented by the above compositional formula. Further, the dehydration for the precursor solution is performed twice. By using such a precursor solution of Example 9, the solid electrolyte pellet for evaluation of Example 9 was produced in the same manner as in Example 1.

### 1-5-10. Production of Solid Electrolyte Pellet for Evaluation of Example 10

The solid electrolyte of Example 10 is a solid electrolyte, in which Sb and Ta are selected as the element M, and which is represented by the compositional formula: Li_{6.2}La₃(Zr_{1.2}Sb_{0.4}Ta_{0.4})O₁₂ being the same as that of Example 9. That is, the value x of the compositional ratio of the element M is 0.8.

The method for producing a solid electrolyte pellet for evaluation of Example 10 is the same as that of Example 9 except that the main firing conditions are changed to 1000° C. and 8 hours from those of Example 9. That is, the dehydration for the precursor solution is performed twice. By using such a precursor solution of Example 10, the solid electrolyte pellet for evaluation of Example 10 was produced in the same manner as in Example 1.

### 1-5-11. Production of Solid Electrolyte Pellet for Evaluation of Comparative Example 1

The solid electrolyte of Comparative Example 1 is a solid electrolyte, in which Sb and Ta are selected as the element M, and which is represented by the compositional formula: Li_{6.3}La₃(Zr_{1.3}Sb_{0.5}Ta_{0.2})O₁₂ being the same as that of Example 5. That is, the value x of the compositional ratio of the element M is 0.7.

In Examples 1 to 10, the solid electrolyte pellets are produced by a liquid-phase method using the precursor solutions. On the other hand, the solid electrolyte pellet for evaluation of Comparative Example 1 is produced by a solid-phase method using solid raw materials. Specifically, 0.2793 g of a powder of lithium carbonate (Li₂CO₃) as the lithium source, 0.2769 g of a powder of lanthanum oxide (La₂O₃) as the lanthanum source, 0.3720 g of a powder of lanthanum zirconate (La₂Zr₂O₇) as the lanthanum source and the zirconium source, 0.0729 g of a powder of antimony trioxide (Sb₂O₃) as the antimony source, and 0.0442 g of a powder of tantalum pentoxide (Ta₂O₅) as the tantalum source were weighed, respectively, and 1 mL (milliliter) of n-hexane manufactured by Kanto Chemical Co., Inc. was added thereto, and the components were mixed using an agate mortar, whereby a mixture was obtained. 0.150 g of this mixture was filled in a pellet die with an exhaust port having an inner diameter of 10 mm manufactured by Specac, Inc., followed by uniaxial press molding under a load of 0.624 kN/mm² (624 MPa), whereby a pellet as a molded material was obtained. The obtained pellet was placed in a crucible made of magnesium oxide and sintered at 1000° C. in an air atmosphere for 8 hours, whereby the solid electrolyte pellet of Comparative Example 1 was obtained. The main firing conditions are set to 1000° C. and 8 hours, and therefore, the mass of lithium carbonate as the lithium source is 1.2 times the compositional ratio of lithium in the above compositional formula. The mass of each of the raw materials of the other elements is equal to the compositional ratio of each of the other elements of the above compositional formula. Note that the theoretical reaction formula (2) when synthesizing the solid electrolyte of Comparative Example 1 is as follows.

0.65La₂Zr₂O₇+3.15Li₂CO₃+0.85La₂O₃+0.25Sb₂O₃+0.10Ta₂O₅+0.25O₂→Li_{6.3}La₃(Zr_{1.3}Sb_{0.5}Ta_{0.2})O₁₂+3.15CO₂↑ (2)

### 1-5-12. Production of Solid Electrolyte Pellet for Evaluation of Comparative Example 2

The solid electrolyte of Comparative Example 2 is a solid electrolyte, in which Sb and Ta are selected as the element M, and which is represented by the compositional formula: Li_{6.3}La₃(Zr_{1.3}Sb_{0.5}Ta_{0.2})O₁₂ being the same as that of Example 5. That is, the value x of the compositional ratio of the element M is 0.7.

The method for producing a solid electrolyte pellet of Comparative Example 2 is the same as that of Example 5 except that the dehydration is not performed for a mixed solution obtained by mixing the raw material solutions of the respective elements. That is, a calcined body is obtained by removing the solvent component from the precursor solution which is not subjected to the dehydration, followed by oxidation. Then, a calcined body pellet was produced using the calcined body, and main firing was performed at 1000° C. for 8 hours for the calcined body pellet, whereby the solid electrolyte pellet of Comparative Example 2 was obtained.

### 1-5-13. Production of Solid Electrolyte Pellet for Evaluation of Comparative Example 3

The solid electrolyte of Comparative Example 3 is a solid electrolyte, in which Sb and Ta are selected as the element M, and which is represented by the compositional formula: Li_{6.3}La₃(Zr_{1.3}Sb_{0.5}Ta_{0.2})O₁₂ being the same as that of Example 5. That is, the value x of the compositional ratio of the element M is 0.7.

In the method for producing a solid electrolyte pellet of Comparative Example 3, a precursor solution is obtained by performing the dehydration once for a mixed solution obtained by mixing the raw material solutions of the respective elements. The other production method is the same as that of Example 5. That is, a calcined body is obtained by removing the solvent component from the precursor solution which was subjected to the dehydration once, followed by oxidation. Then, a calcined body pellet was produced using the calcined body, and main firing was performed at 1000° C. for 8 hours for the calcined body pellet, whereby the solid electrolyte pellet of Comparative Example 3 was obtained.

### 1-5-14. Production of Solid Electrolyte Pellet for Evaluation of Comparative Example 4

The solid electrolyte of Comparative Example 4 is a solid electrolyte, in which only Nb is selected from Nb, Ta, and Sb as the element M, and which is represented by the compositional compositional ratio of the element M is 0.25.

In the method for producing a solid electrolyte pellet of Comparative Example 4, first, a 2-n-butoxyethanol+2,4-pentanedione precursor solution of the solid electrolyte represented by the compositional formula: Li_{6.75}La₃(Zr_{1.75}Nb_{0.25})O₁₂ at 1 mol/kg is prepared. Specifically, the precursor solution is prepared to contain 8.100 g of the 2-n-butoxyethanol solution of lithium nitrate at 1 mol/kg, 3.000 g of the 2-n-butoxyethanol solution of lanthanum nitrate hexahydrate at 1 mol/kg, 1.750 g of the 2,4-pentanedione solution of zirconium tetra-n-butoxide at 1 mol/kg, 0.250 g of the 2-n-butoxyethanol solution of niobium pentaethoxide at 1 mol/kg, and 2-n-butoxyethanol and 2,4-pentanedione as the organic solvents. The method for preparing the precursor solution is basically the same as that of Example 1, and the main firing conditions are set to 1000° C. and 8 hours, and therefore, the mass of the 2-n-butoxyethanol solution of lithium nitrate at 1 mol/kg is 8.100 g that is 1.20 times the compositional ratio of lithium represented by the above compositional formula. Further, the dehydration for the precursor solution is performed twice. By using the precursor solution of Comparative Example 4 containing two types of organic solvents in this manner, the solid electrolyte pellet for evaluation of Comparative Example 4 was produced in the same manner as in Example 1.

### 1-5-15. Production of Solid Electrolyte Pellet for Evaluation of Comparative Example 5

The solid electrolyte of Comparative Example 5 is a solid electrolyte, in which Sb and Ta are selected as the element M, and which is represented by the compositional formula: Li_{6.2}La₃(Zr_{1.2}Sb_{0.4}Ta_{0.4})O₁₂ being the same as that of Example 9. The value x of the compositional ratio of the element M is 0.4+0.4=0.8.

In the method for producing a solid electrolyte pellet of Comparative Example 5, first, a 2-n-butoxyethanol+2,4-pentanedione precursor solution of the solid electrolyte represented by the compositional formula: Li_{6.2}La₃(Zr_{1.2}Sb_{0.4}Ta_{0.4})O₁₂ at 1 mol/kg is prepared. Specifically, the precursor solution is prepared to contain 7.440 g of the 2-n-butoxyethanol solution of lithium nitrate at 1 mol/kg, 3.000 g of the 2-n-butoxyethanol solution of lanthanum nitrate hexahydrate at 1 mol/kg, 1.200 g of the 2,4-pentanedione solution of zirconium tetra-n-butoxide at 1 mol/kg, 0.400 g of the 2-n-butoxyethanol solution of antimony n-butoxide at 1 mol/kg, 0.400 g of the 2-n-butoxyethanol solution of tantalum pentaethoxide at 1 mol/kg, and 2-n-butoxyethanol and 2,4-pentanedione as the organic solvents. The method for preparing the precursor solution is basically the same as that of Example 1, and the main firing conditions are set to 1000° C. and 8 hours, and therefore, the mass of the 2-n-butoxyethanol solution of lithium nitrate at 1 mol/kg is 7.440 g that is 1.20 times the compositional ratio of lithium represented by the above compositional formula. Further, the dehydration for the precursor solution is performed twice. By using the precursor solution of Comparative Example 5 containing two types of organic solvents in this manner, the solid electrolyte pellet for evaluation of Comparative Example 5 was produced in the same manner as in Example 1.

### 1-6. Evaluation of Precursor Solutions of Solid Electrolytes and Solid Electrolyte Pellets of Examples and Comparative Examples

### 1-6-1. Moisture Amount in Precursor Solutions of Solid Electrolytes of Examples and Comparative Examples

The amount of moisture contained in each of the precursor solutions of Examples 1 to 10 and Comparative Examples 2 to in which the liquid-phase method was used excluding Comparative Example 1 in which the solid-phase method was used was measured by the Karl Fischer method using a trace moisture meter, AQS-2110ST manufactured by Hiranuma Sangyo Co., Ltd. The measurement results are shown in Table 3 below.

### 1-6-2. Compositions of Precursor Solutions of Solid Electrolytes of Examples and Comparative Examples

With respect to the precursor solutions of Examples 1 to 10 and Comparative Examples 2 to 5 in which the liquid-phase method was used excluding Comparative Example 1 in which the solid-phase method was used, a metal element ratio analysis was performed using an ICP-AES measurement device Agilent 5110 manufactured by Agilent Technologies Japan, Ltd.

Specifically, each of the precursor solutions of Examples 1 to 10 and Comparative Examples 2 to 5 was placed in a dish made of titanium, and the dish was placed on a hot plate set to 140° C. and heated for 1 hour and 30 minutes, thereby drying the solvent component by evaporation. The obtained solid component was thermally melted by adding potassium pyrosulfate thereto, followed by acid dissolution, whereby a measurement sample was formed. The value x of the compositional ratio of the element M obtained by the metal element analysis is shown in Table 3 below.

### 1-6-3. Compositions and Crystal Structures of Solid Electrolytes of Examples and Comparative Examples

Each of the solid electrolyte pellets of Examples 1 to 10 and Comparative Examples 1 to 5 was used as a sample and analyzed with an X-ray diffractometer X'Pert-PRO manufactured by Royal Philips, whereby X-ray diffraction patterns were obtained. From the obtained X-ray diffraction patterns, the presence or absence of byproducts was confirmed in the compositions of the solid electrolytes of Examples 1 to 10 and Comparative Examples 1 to 5. Further, a Raman scattering spectrum was obtained using a Raman spectrometer S-2000 (manufactured by JEOL Ltd.), and a crystal system was specified. With respect to the crystal structure of each of the solid electrolytes of Examples 1 to 10 and Comparative Examples 1 to 5, a tetragonal crystal structure is denoted as “t”, and a cubic crystal structure is denoted as “c” in Table 3 below.

### 1-6-4. Total Lithium Ion Conductivities of Solid Electrolyte Pellets of Examples and Comparative Examples

A metal lithium foil having a diameter ϕ of 5 mm is pressed against the both faces of each of the solid electrolyte pellets of Examples 1 to 10 and Comparative Examples 1 to 5, whereby activated electrodes are formed. Then, an electrochemical impedance (EIS) was measured using an AC impedance analyzer Solartron 1260 manufactured by Solartron Anailtical, Inc., and the total lithium ion conductivity was determined. The EIS measurement was performed at an alternating current (AC) amplitude of 10 mV (millivolts) in a frequency range from 10⁷ Hz (hertz) to 10⁻¹ Hz. The total lithium ion conductivity obtained by the EIS measurement includes the bulk lithium ion conductivity and the grain boundary lithium ion conductivity in each solid electrolyte pellet. The total lithium ion conductivity of each of the solid electrolyte pellets of Examples 1 to 10 and Comparative Examples 1 to 5 is shown in Table 3.

Table 3 is a table showing the compositional formula of each of the solid electrolytes of Examples 1 to 10 and Comparative Examples 1 to 5, the value x of the compositional ratio of the element M in the compositional formula, the amount of moisture (ppm) in the precursor solution, the main firing conditions (sintering temperature and sintering time), the confirmation result of the crystal structure (crystal system) by XRD, and the total lithium ion conductivity (siemens/centimeter: S·cm⁻¹). Note that in Comparative Example 1, the solid electrolyte pellet is produced using the solid-phase method, and therefore, it is excluded from the measurement target of the moisture amount in the precursor solution.

TABLE 3

| | | | | Moisture | | | Total lithium |
|---|---|---|---|---|---|---|---|
| | | | | amount | Main firing | Crystal | ion conductivity |
| | Composition of solid electrolyte | Synthesis method | x | (ppm) | conditions | system | (S · cm⁻¹) |
| Example 1 | Li_{6.7}La₃(Zr_{1.7}Nb_{0.25}Ta_{0.05})O₁₂ | Liquid-phase | 0.30 | 7 | 900° C. × 8H | c | 1.0 × 10⁻³ |
| | | method | | | | | |
| Example 2 | Li_{6.7}La₃(Zi_{1.7}Nb_{0.25}Ta_{0.05})O₁₂ | Liquid-phase | 0.30 | 7 | 1,000° C. × 8H | c | 1.0 × 10⁻³ |
| | | method | | | | | |
| Example 3 | Li_{6.35}La₃(Zr_{1.35}Nb_{0.25}Sb_{0.4})O₁₂ | Liquid-phase | 0.65 | 10 | 900° C. × 8H | c | 6.8 × 10⁻⁴ |
| | | method | | | | | |
| Example 4 | Li_{6.7}La₃(Zr_{1.7}Nb_{0.25}Ta_{0.05})O₁₂ | Liquid-phase | 0.65 | 10 | 1,000° C. × 8H | c | 6.8 × 10⁻⁴ |
| | | method | | | | | |
| Example 5 | Li_{6.3}La₃(Zr_{1.3}Sb_{0.5}Ta_{0.2})O₁₂ | Liquid-phase | 0.70 | 8 | 900° C. × 8H | c | 7.0 × 10⁻⁴ |
| | | method | | | | | |
| Example 6 | Li_{6.3}La₃(Zr_{1.3}Sb_{0.5}Ta_{0.2})O₁₂ | Liquid-phase | 0.70 | 8 | 1,000° C. × 8H | c | 7.0 × 10⁻⁴ |
| | | method | | | | | |
| Example 7 | Li_{5.95}La₃(Zr_{0.95}Nb_{0.25}Sb_{0.4}Ta_{0.4})O₁₂ | Liquid-phase | 1.05 | 6 | 900° C. × 8H | c | 6.6 × 10⁻⁴ |
| | | method | | | | | |
| Example 8 | Li_{5.95}La₃(Zr_{0.95}Nb_{0.25}Sb_{0.4}Ta_{0.4})O₁₂ | Liquid-phase | 1.05 | 6 | 1,000° C. × 8H | c | 6.6 × 10⁻⁴ |
| | | method | | | | | |
| Example 9 | Li_{6.2}La₃(Zr_{1.2}Sb_{0.4}Ta_{0.4})O₁₂ | Liquid-phase | 0.80 | 8 | 900° C. × 8H | c | 6.6 × 10⁻⁴ |
| | | method | | | | | |
| Example 10 | Li_{6.2}La₃(Zr_{1.2}Sb_{0.4}Ta_{0.4})O₁₂ | Liquid-phase | 0.80 | 8 | 1,000° C. × 8H | c | 6.6 × 10⁻⁴ |
| | | method | | | | | |
| Comparative | Li_{6.3}La₃(Zr_{1.3}Sb_{0.5}Ta_{0.2})O₁₂ | Solid-phase | 0.70 | — | 1,000° C. × 8H | t | 5.4 × 10⁻⁵ |
| Example 1 | | method | | | | | |
| Comparative | Li_{6.3}La₃(Zr_{1.3}Sb_{0.5}Ta_{0.2})O₁₂ | Liquid-phase | 0.70 | 200 | 1,000° C. × 8H | c | 1.2 × 10⁻⁴ |
| Example 2 | | method | | | | | |
| Comparative | Li_{6.3}La₃(Zr_{1.3}Sb_{0.5}Ta_{0.2})O₁₂ | Liquid-phase | 0.70 | 14 | 1,000° C. × 8H | c | 1.5 × 10⁻⁴ |
| Example 3 | | method | | | | | |
| Comparative | Li_{6.75}La₃(Zr_{1.75}Nb_{0.25})O₁₂ | Liquid-phase | 0.25 | 8 | 1,000° C. × 8H | t | 9.0 × 10⁻⁷ |
| Example 4 | | method | | | | | |
| Comparative | Li_{6.2}La₃(Zr_{1.2}Sb_{0.4}Ta_{0.4})O₁₂ | Liquid-phase | 0.80 | 9 | 1,000° C. × 8H | c | 2.0 × 10⁻⁶ |
| Example 5 | | method | | | | | |

As shown in Table 3, the moisture amount in each of the precursor solutions of Examples 1 and 2 was 7 ppm, the moisture amount in each of the precursor solutions of Examples 3 and 4 was 10 ppm, the moisture amount in each of the precursor solutions of Examples 5 and 6 was 8 ppm, the moisture amount in each of the precursor solutions of Examples 7 and 8 was 6 ppm, the moisture amount in each of the precursor solutions of Examples 9 and 10 was 8 ppm, the moisture amount in the precursor solution of Comparative Example 4 was 8 ppm, and the moisture amount in the precursor solution of Comparative Example 5 was 9 ppm. That is, when the dehydration was performed twice as described above for the mixed solution obtained by mixing the raw material solutions of the respective elements, the moisture amount was 10 ppm or less. On the other hand, among Comparative Examples 2 to 5 in which the liquid-phase method was used, the moisture amount in the precursor solution of Comparative Example 2 in which the dehydration was not performed for the mixed solution was 200 ppm. Further, the moisture amount in the precursor solution of Comparative Example 3 in which the dehydration was performed only once was 14 ppm.

The solid electrolytes of Examples 1 to 10 and Comparative Examples 2 and 3 produced by the liquid-phase method using the precursor solutions containing one type of organic solvent, and the solid electrolyte of Comparative Example 5 produced by the liquid-phase method but using the precursor solution containing two types of organic solvents have a cubic crystal structure. The solid electrolyte of Comparative Example 1 produced using the solid-phase method and the solid electrolyte of Comparative Example 4 produced by the liquid-phase method but using the precursor solution containing two types of organic solvents have a tetragonal crystal structure.

Among the solid electrolytes represented by the composition formula Li₇₋ₓLa₃(Zr₂₋ₓMₓ)O₁₂ of Examples 1 to 10, Examples 1 and 2 in which two types: Nb and Ta were selected as the element M and the value of the compositional ratio x was 0.3 showed the highest total lithium ion conductivity value (1.0×10⁻³S/cm). The total lithium ion conductivity values of Examples 3 to 10 in which two types or three types were selected from Nb, Sb, and Ta as the element M were from 6.0×10⁻⁴ S/cm to 7.0×10⁻⁴ S/cm.

On the other hand, the total lithium ion conductivity of the solid electrolyte of Comparative Example 1, in which two types: Sb and Ta were selected as the element M and the value of the compositional ratio x was 0.7, and which was produced by the solid-phase method, was 5.4×10⁻⁵S/cm, and was a lower value by one digit than that of Example 5 or 6 in which the liquid-phase method was used and the composition was the same. This is because the primary average particle diameter of the raw material particles used in the solid-phase method is more than 10 μm that is larger by two digits or more as compared to several hundred nanometers of the primary average particle diameter of the calcined body obtained by the liquid-phase method, and therefore, the tetragonal-cubic transition point was shifted to a high-temperature side, and transition from a tetragonal crystal to a cubic crystal did not sufficiently proceed at 1000° C. On the other hand, the reason why a high total lithium ion conductivity is obtained in the solid electrolyte pellets produced by the liquid-phase method of Examples 1 to 10 is considered to be because the primary average particle diameter of the calcined body is as small as several hundred nanometers, and the tetragonal-cubic transition point is shifted to a low-temperature side, and transition to a cubic crystal sufficiently occurs, and also lowering of the sintering temperature simultaneously occurs, and thus, a dense lithium composite metal oxide is obtained.

Further, the total lithium ion conductivity of the solid electrolyte of Comparative Example 2 in which the moisture amount in the precursor solution is the largest is 1.2×10⁻⁴ S/cm, and the total lithium ion conductivity of the solid electrolyte of Comparative Example 3 in which the moisture amount in the precursor solution is 14 ppm which is more than 10 ppm is 1.5×10⁻⁴ S/cm, and both conductivities were lower values than those of Example 5 or 6 having the same composition. This is considered to be because an alkoxide of Zr, Sb, or Ta caused a condensation reaction due to moisture contained in the precursor solution, and the total lithium ion conductivity was lowered due to a byproduct generated during the firing of the oxide.

Further, the solid electrolyte of Comparative Example 4 had a total lithium ion conductivity of 9.0×10⁻⁷ S/cm although the moisture amount in the precursor solution was 8 ppm which is less than 10 ppm. This is considered to be because the boiling points of the two types of organic solvents contained in the precursor solution are not the same, and the solubility of the raw material solution of each element in the two types of organic solvents is different, and therefore, a byproduct was generated during calcination at 540° C. or main firing at 1000° C. or the crystal structure became tetragonal instead of cubic, and thus the total lithium ion conductivity was lowered.

Further, the solid electrolyte of Comparative Example 5 had a total lithium ion conductivity of 2.0×10⁻⁶ S/cm although the moisture amount in the precursor solution was 9 ppm which is less than 10 ppm. This is considered to be because the boiling points of the two types of organic solvents contained in the precursor solution are not the same, and the solubility of the raw material solution of each element in the two types of organic solvents is different, and therefore, although the crystal structure was cubic, a byproduct was generated during calcination at 540° C. or main firing at 1000° C. and the byproduct was present at the grain boundary interface of the solid electrolyte so as to block the lithium ion conduction path, and thus the total lithium ion conductivity was lowered.

According to the precursor solution of a solid electrolyte of this embodiment, the following effects are obtained.

1) In the precursor solution, one type of organic solvent is selected as a solvent, and therefore, as compared to a case where a mixed solvent is used, generation of a byproduct by firing in the process for forming a solid electrolyte is suppressed, so that a precursor solution of a solid electrolyte capable of realizing a solid electrolyte represented by the following compositional formula (1) and having a high lithium ion conductivity can be achieved.

Li₇₋ₓLa₃(Zr₂₋ₓMₓ)O₁₂ (1)

In the compositional formula, the element M is two or more types of elements selected from Nb, Ta, and Sb, and x satisfies 0.0<x<2.0.

2) The lithium compound and the lanthanum compound contained in the precursor solution are preferably nitrate compounds, and the zirconium compound and the compound containing the element M contained in the precursor solution are preferably alkoxides. According to this, the solubility in the organic solvent can be ensured. Further, by using a nitrate, a byproduct is less likely to be generated, and a cubic solid electrolyte that is a desired oxide having high denseness can be obtained. Specifically, in the precursor solution, when an alkoxide is increased, carbon is increased, and the reaction equilibrium when forming a solid electrolyte is disrupted and La₂Zr₂O₇ as a byproduct is likely to be generated, however, it has an advantage that film formation is easily made uniform. On the other hand, a nitrate has an overwhelmingly low carbon content as compared to an alkoxide, and leads the reaction equilibrium to the solid electrolyte side, and therefore, La₂Zr₂O₇ as a byproduct is less likely to be generated. In addition, when the compounds of the elements contained in the raw material solutions constituting the precursor solution are all alkoxides, film formation can be made uniform, however, it has a disadvantage that the denseness is deteriorated. By including a nitrate in the precursor solution, the nitrate acts as a melt, and therefore, a film having high uniformity and denseness can be formed.

3) The dehydration is performed twice when preparing the precursor solution, and the moisture amount is set to 10 ppm or less, and therefore, even when metal salt compounds are used as the lithium compound and the lanthanum compound, the metal salts do not function as acids, and thus, even when the metal salts are mixed with, for example, the positive electrode active material 11 as other compounds, they do not erode the positive electrode active material 11. Further, even when alkoxides are used as the zirconium compound and the compound containing the element M, a condensation reaction is less likely to occur. That is, the solid electrolyte 12 having a high lithium ion conductivity can be formed. In addition, the positive electrode composite 10 including the solid electrolyte 12 having a high lithium ion conductivity can be formed. In other words, the lithium-ion battery 100 having excellent charge-discharge characteristics can be provided. Note that from the viewpoint of easily setting the moisture amount in the precursor solution to 10 ppm or less by the dehydration, it is preferred that the organic solvent is a nonaqueous organic solvent that is less likely to dissolve moisture. By using the nonaqueous organic solvent, it becomes possible to keep the moisture amount in the precursor solution 10 ppm or less, so that a precursor solution of a solid electrolyte having excellent storage stability for a long period of time can be achieved.

4) In the precursor solution, it is preferred that the zirconium alkoxide and the alkoxide of the element M have 4 or more and 8 or less carbon atoms or have a boiling point of 300° C. or higher.

An alkoxide having less than 4 carbon atoms shows hydrophilicity and tends to cause a condensation reaction through moisture, and there is a fear that a byproduct is generated during firing of the oxide. On the other hand, when an alkoxide has more than 8 carbon atoms, the solubility of the alkoxide in the organic solvent decreases. Therefore, by selecting an alkoxide having 4 or more and 8 or less carbon atoms or having a boiling point of 300° C. or higher, the solid electrolyte represented by the above compositional formula (1) can be reliably achieved.

Note that the invention is not limited to the above-mentioned embodiments, and various changes, improvements, etc. can be added to the above-mentioned embodiments. A modification will be described below.

### (First Modification)

The secondary battery to which the solid electrolyte 12 formed using the precursor solution of a solid electrolyte of this embodiment is applied is not limited to the lithium-ion battery 100 of the above-mentioned embodiment. For example, the secondary battery may have a configuration in which a porous separator is provided between the positive electrode composite and the negative electrode 30, and the separator is impregnated with an electrolytic solution. Further, for example, the negative electrode 30 may be a negative electrode composite material including a negative electrode active material and the solid electrolyte 12. In addition, for example, a configuration in which the electrolyte layer 20 composed of the solid electrolyte 12 of this embodiment is provided between the positive electrode composite 10 and the negative electrode composite material may be adopted.

Hereinafter, contents derived from the embodiments will be described.

A precursor solution of a solid electrolyte of this application is a precursor solution of a garnet-type solid electrolyte represented by the compositional formula: Li₇₋ₓLa₃(Zr₂₋ₓMₓ)O₁₂, and is characterized in that in the compositional formula, the element M is two or more types of elements selected from Nb, Ta, and Sb, and x satisfies 0.0<x<2.0, the precursor solution contains one type of organic solvent, and a lithium compound, a lanthanum compound, a zirconium compound, and a compound containing the element M, each of which has solubility in the organic solvent, and with respect to the stoichiometric composition of the compositional formula, the amount of the lithium compound is 1.05 times or more and 1.20 times or less, the amount of the lanthanum compound is equal, the amount of the zirconium compound is equal, and the amount of the compound containing the element M is equal.

According to the configuration of this application, one type of organic solvent is selected as a solvent, and therefore, as compared to a case where a mixed solvent is used, generation of a byproduct by firing in the process for forming a solid electrolyte is suppressed, so that a precursor solution of a solid electrolyte capable of realizing a solid electrolyte represented by the above compositional formula and having a desired lithium ion conductivity can be provided.

In the precursor solution of a solid electrolyte described above, it is preferred that the lithium compound is a lithium metal salt compound, the lanthanum compound is a lanthanum metal salt compound, the zirconium compound is a zirconium alkoxide, and the compound containing the element M is an alkoxide of the element M.

According to the configuration, the solubility of the lithium compound, the lanthanum compound, the zirconium compound, and the compound containing the element M in the organic solvent can be ensured.

In the precursor solution of a solid electrolyte described above, it is preferred that the lithium metal salt compound and the lanthanum metal salt compound are nitrates.

According to the configuration, a nitrate has an overwhelmingly low carbon content as compared to an alkoxide, and leads the reaction equilibrium in the formation of the solid electrolyte to the solid electrolyte side, and therefore, La₂Zr₂O₇ as a byproduct is less likely to be generated. In addition, when the compounds of the elements contained in the raw material solutions constituting the precursor solution are all alkoxides, film formation of the solid electrolyte can be made uniform, however, it has a disadvantage that the denseness is deteriorated. By including a nitrate in the precursor solution, the nitrate acts as a melt, and therefore, a film of a solid electrolyte having high uniformity and denseness can be formed.

It is preferred that the amount of moisture contained in the precursor solution of a solid electrolyte described above is 10 ppm or less.

According to the configuration, when moisture is contained, there is a fear that a metal salt functions as an acid to change the composition of the other element compounds. Further, when a compound that is a raw material is an alkoxide, the alkoxide causes a condensation reaction through moisture, and there is a fear that a byproduct is generated during firing of the oxide. Therefore, by setting the amount of moisture contained in the precursor solution of a solid electrolyte to 10 ppm or less, the solid electrolyte represented by the above compositional formula can be reliably achieved.

In the precursor solution of a solid electrolyte described above, it is preferred that the zirconium alkoxide and the alkoxide of the element M have 4 or more and 8 or less carbon atoms or have a boiling point of 300° C. or higher.

According to the configuration, an alkoxide having less than 4 carbon atoms shows hydrophilicity and tends to cause a condensation reaction through moisture, and there is a fear that a byproduct is generated during firing of the oxide. On the other hand, when an alkoxide has more than 8 carbon atoms, the solubility of the alkoxide in the organic solvent decreases. Therefore, by selecting an alkoxide having 4 or more and 8 or less carbon atoms or having a boiling point of 300° C. or higher, the solid electrolyte represented by the above compositional formula can be reliably achieved.

In the precursor solution of a solid electrolyte described above, it is preferred that the organic solvent is nonaqueous and is selected from n-butyl alcohol, ethylene glycol monobutyl ether, butylene glycol, hexylene glycol, pentanediol, hexanediol, heptanediol, toluene, o-xylene, p-xylene, hexane, heptane, and octane.

According to the configuration, these organic solvents that are nonaqueous hardly contain moisture, and therefore, the solid electrolyte represented by the above compositional formula can be reliably achieved.

1. A precursor solution of a solid electrolyte, which is a precursor solution of a garnet-type solid electrolyte represented by the compositional formula: Li₇₋ₓLa₃(Zr₂₋ₓMₓ)O₁₂, wherein
in the compositional formula, the element M is two or more types of elements selected from Nb, Ta, and Sb, and x satisfies 0.0<x<2.0,
the precursor solution contains
one type of organic solvent, and
a lithium compound, a lanthanum compound, a zirconium compound, and a compound containing the element M, each of which has solubility in the organic solvent, and
with respect to the stoichiometric composition of the compositional formula, the amount of the lithium compound is 1.05 times or more and 1.20 times or less, the amount of the lanthanum compound is equal, the amount of the zirconium compound is equal, and the amount of the compound containing the element M is equal.

2. The precursor solution of a solid electrolyte according to claim 1, wherein
the lithium compound is a lithium metal salt compound,
the lanthanum compound is a lanthanum metal salt compound,
the zirconium compound is a zirconium alkoxide, and
the compound containing the element M is an alkoxide of the element M.

3. The precursor solution of a solid electrolyte according to claim 2, wherein the lithium metal salt compound and the lanthanum metal salt compound are nitrates.

4. The precursor solution of a solid electrolyte according to claim 2, wherein the amount of moisture contained in the precursor solution of a solid electrolyte is 10 ppm or less.

5. The precursor solution of a solid electrolyte according to claim 2, wherein the zirconium alkoxide and the alkoxide of the element M have 4 or more and 8 or less carbon atoms or have a boiling point of 300° C. or higher.

6. The precursor solution of a solid electrolyte according to claim 1, wherein the organic solvent is nonaqueous and is selected from n-butyl alcohol, ethylene glycol monobutyl ether, butylene glycol, hexylene glycol, pentanediol, hexanediol, heptanediol, toluene, o-xylene, p-xylene, hexane, heptane, and octane.

7. The precursor solution of a solid electrolyte according to claim 3, wherein the zirconium alkoxide and the alkoxide of the element M have 4 or more and 8 or less carbon atoms or have a boiling point of 300° C. or higher.

8. The precursor solution of a solid electrolyte according to claim 4, wherein the zirconium alkoxide and the alkoxide of the element M have 4 or more and 8 or less carbon atoms or have a boiling point of 300° C. or higher.
